(19) United States
(12) Patent Application Publication
(10) Pub. No.: US 2024/0064072 A1
(43) Pub. Date: Feb. 22, 2024

(54) Methods and Apparatuses for Supporting Quality of Experience Measurements

(71) Applicant: Telefonaktiebolaget LM Ericsson (publ), Stockholm (SE)

(72) Inventors: Luca Lunardi, Genoa (IT); Johan Rune, Lidingö (SE); Gunnar Heikkilä, Gammelstad (SE); Filip Barac, Huddinge (SE)

(21) Appl. No.: 18/270,744

(22) PCT Filed: Dec. 8, 2021
(86) PCT No.: PCT/SE2021/051223

§ 371 Date: Jul. 3, 2023

Related U.S. Application Data
(60) Provisional application No. 63/137,288, filed on Jan. 14, 2021.

(51) Int. Cl. H04L 41/5067; H04W 24/10

(52) U.S. Cl. CPC H04L 41/5067; H04W 24/10

(57) ABSTRACT

A first example of a method according to an embodiment of the invention comprises a method performed by a wireless device for initiating performance of Quality of Experience, QoE, measurements for a first application. The wireless device receives (402), from a base station, a first request to perform one or more measurements according to a QoE measurement configuration, wherein the request comprises an indication of the QoE measurement configuration, wherein the QoE measurement configuration is associated with a service type of a first application and at least one service subtype of the first application. The wireless device initiates (404) one or more QoE measurements according to the QoE measurement configuration; and transmits (406) a QoE measurement report comprising results of the one or more QoE measurements to the base station.

### TECHNICAL FIELD

This disclosure relates to the field of telecommunication networks, and in particular to methods and apparatuses for initiating performance of Quality of Experience measurements for a first application.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

QoE Measurements in Legacy Solution

Quality of Experience (QoE) measurements have been specified for Long Term Evolution (LTE) and Universal Mobile Telecommunications Service (UMTS) and it is being specified for New Radio (NR). The purpose of these application layer measurements is to measure the end user experience when using certain applications. Currently QoE measurements for streaming services and for MTSI (Mobility Telephony Service for IMS) services are supported.

The solutions in LTE and UMTS are similar with the overall principles as follows. Quality of Experience Measurement Collection enables configuration of application layer measurements in the User Equipment (UE) and transmission of QoE measurement result files by means of Radio Resource Control (RRC) signalling. Application layer measurement configuration received from operations, administration and maintenance (OAM) or the Core Network (CN) is encapsulated in a transparent container, which is forwarded to a user equipment (UE) in a downlink RRC message. Application layer measurements received from UE's higher layer are encapsulated in a transparent container and sent to network in an uplink RRC message. The result container is forwarded to a TCE, Trace Collector Entity (or Measurement Collector Entity (MCE)).

In 3GPP release 17 a new study item for “Study on NR QoE management and optimizations for diverse services” for NR has been approved. The purpose of the study item is to study solutions for QoE measurements in NR. QoE management in NR will not just collect the experience parameters of streaming services but also consider the typical performance requirements of diverse services (e.g. AR/VR and URLLC). Based on requirements of services, the NR study will also include more adaptive QoE management schemes that enable network intelligent optimization to satisfy user experience for diverse services.

The measurements may be initiated towards the Radio Access Network (RAN) in management-based manner, i.e. from an OAM node in a generic way e.g. for a group of UEs, or they may also be initiated in a signaling-based manner, i.e. initiated from CN to RAN e.g. for a single UE. The configuration of the measurements includes the measurement details, which is encapsulated in a container that is transparent to RAN.

When initiated via the core network, the measurement may be started towards a specific UE. For the LTE case, the “TRACE START” S1 Application Protocol (S1AP) message is used, which carries, among others, the details about the measurement configuration the application should collect (in the “Container for application layer measurement configuration” IE, transparent to the RAN) and the details to reach the trace collection entity to which the measurements should be sent.

RAN is not aware of when the streaming session is ongoing in the UE Access Stratum and is also not aware of when the measurements are ongoing. It is an implementation decision when RAN stops the measurements. Typically, it is done when the UE has moved outside the measured area.

One opportunity provided by legacy solution is also to be able to keep the QoE measurement for the whole session, even during handover situation.

### QoE Measurement in E-UTRAN

### E-UTRAN—Application Layer Measurement Capabilities

For E-UTRAN, the UE capability transfer is used to transfer UE radio access capability information from the UE to E-UTRAN (see FIG. 1—UE capability transfer—E-UTRAN).

The UE-EUTRA-Capability IE is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the UE-EUTRA-Capability-v1530-IE which can be used by the UE to indicate whether the UE supports or not QoE Measurement Collection for streaming services and/or MTSI services, as detailed in the “MeasParameters-v1530” encoding below.

The contribution CR 4297 (R2-2004624) for 3GPP TS 36.331 v16.0.0 at the 3GPP TSG RAN2 Meeting #110 proposed an extension of the “UE-EUTRA-Capability” IE that, within the “UE-EUTRA-Capability-v16xy-IE” may include a “measParameters-v16xy” comprising the qoe-Extensions-r16 IE. The qoe-Extensions-r16 IE may be used to indicate whether the UE supports the release 16 extensions for QoE Measurement Collection, i.e. if the UE supports more than one QoE measurement type at a time and if the UE supports the signaling of withinArea, sessionRecordingIndication, qoe-Reference, temporaryStopQoE and restartQoE.

### E-UTRAN—Application Layer Measurement Reporting

The purpose of the “Application layer measurement reporting” procedure described in 3GPP TS 36.331 and shown in FIG. 2 is to inform E-UTRAN about application layer measurement report. FIG. 2 shows Application layer measurement reporting in E-UTRAN.

A UE capable of application layer measurement reporting in RRC_CONNECTED may initiate the procedure when configured with application layer measurement, i.e. when measConfigAppLayer has been configured by E-UTRAN.

Upon initiating the procedure, the UE shall:
1> if configured with application layer measurement, and SRB4 is configured, and the UE has received application layer measurement report information from upper layers:
2> set the measReportAppLayerContainer in the MeasReportAppLayer message to the value of the application layer measurement report information;
2> set the serviceType in the MeasReportAppLayer message to the type of the application layer measurement report information;
2> submit the MeasReportAppLayer message to lower layers for transmission via SRB4.

### E-UTRAN—QoE Measurement Configuration Setup and Release—RRC Signaling

The RRCConnectionReconfiguration message is used to reconfigure the UE to setup or release the UE for Application Layer measurements. This is signaled in the measConfigAppLayer-15 IE within the “OtherConfig” IE.

The setup includes the transparent container measConfigAppLayerContainer which specifies the QoE measurement configuration for the Application of interest and the serviceType IE to indicates the Application (or service) for which the QoE measurements are being configured. Supported services may be streaming and MTSI.

The contribution CR 4297 (R2-2004624) for 3GPP TS 36.331 v16.0.0 at the 3GPP TSG RAN2 Meeting #110 proposed to extend the QoE measurement configuration.

The measConfigAppLayerToAddModList-r16 may be used to add or modify multiple QoE measurement configurations (up to maxQoE-Measurement-r16). The measConfigAppLayerToReleaseList-r16 IE may be used to remove multiple QoE measurement configuration (up to maxQoE-Measurement-r16).

### E-UTRAN—QoE Measurement Reporting—RRC Signaling

As specified in 3GPP TS 36.331, the MeasReportAppLayer RRC message is used by the UE to send to the E-UTRAN node the QoE measurement results of an Application (or service). The service for which the report is being sent is indicated in the “serviceType” IE.

The contribution CR 4297 (R2-2004624) for 3GPP TS 36.331 v16.0.0 at the 3GPP TSG RAN2 Meeting #110 proposed to extend the MeasReportAppLayer IEs introducing a QoE reference comprising the Public Land Mobile Network (PLMN) identity and the identifier of the QoE Measurement Collection

For E-UTRAN, an example of desired UE behavior for Application layer measurement reporting is described in CR 4297 (R2-2004624):

### UE Application Layer Measurement Configuration

The “UE Application layer measurement configuration” IE is described in 3GPP TS 36.413 v16.3.0 and TS 36.423 v16.3.0.

### Area Scope for QoE Measurements

According to 3GPP TS 28.405, the area scope parameter defines the area in terms of cells or Tracking Area/Routing Area/Location Area where the QoE Measurement Collection (QMC) shall take place. If the parameter is not present the QMC shall be done throughout the PLMN specified in PLMN target.

The area scope parameter in UMTS is either:
List of cells, identified by CGI. Maximum 32 CGI can be defined.
List of Routing Area, identified by RAI. Maximum of 8 RAIs can be defined.
List of Location Area, identified by LAI. Maximum of 8 LAIs can be defined.
   The area scope parameter in LTE is either:
list of cells, identified by E-UTRAN-CGI. Maximum 32 CGI can be defined.
List of Tracking Area, identified by TAC. Maximum of 8 TAC can be defined.
   The parameter is mandatory if area based QMC is requested.

### Time Sensitive Communication

According to 3GPP TS 23.501 v16.6.0, the 5G System is extended to support Time Sensitive Communication as defined in IEEE 802.1 Time Sensitive Networking (TSN) standards. The 5G System is integrated with the external network as a TSN bridge.

This “logical” TSN bridge (FIG. 3) comprises TSN Translator functionality for interoperation between TSN System and 5G System both for user plane and control plane. 5G System (5GS) TSN translator functionality consists of Device-side TSN translator (DS-TT) and Network-side TSN translator (NW-TT). The TSN Application Function (AF) provides the control plane translator functionality for the integration of the 5GS with a TSN network, e.g. the interactions with the Centralized Network Controller (CNC). 5G System specific procedures in 5G Core (5GC) and RAN, wireless communication links, etc. remain hidden from the TSN network. To achieve such transparency to the TSN network and the 5GS to appear as any other TSN Bridge, the 5GS provides TSN ingress and egress ports via DS-TT and NW-TT. The system architecture view with 5GS appearing as TSN bridge is shown in FIG. 3. FIG. 3 shows System architecture view with 5GS appearing as TSN bridge

### SUMMARY

There currently exist certain challenge(s). In the current solution only one QoE measurement and reporting configuration and the associated QoE reporting can be used for a given service type. Hence, the current QoE measurement and reporting configuration framework is limited, and too coarse to allow rich and refined examination of QoE that a network (including an O&M system and AI based entities) may require to perform accurate optimizations in the network and its operation.

Furthermore, the current QoE measurement configuration framework is rigid in the sense that for a certain service type, there is a certain set of QoE metrics that may be reported, while the possibility to focus on different sets of QoE metrics to focus on different aspects or properties of services of the same service type is lacking.

Certain aspects of the present disclosure and their embodiments may provide solutions to these or other challenges.

The proposed solution introduces support for multiple QoE measurements configurations and associated reporting for one or a list of services.

There are, proposed herein, various embodiments which address one or more of the issues disclosed herein.

According to a first aspect, there is provided a method performed by a wireless device for initiating performance of Quality of Experience, QoE, measurements for a first application. The method comprises receiving, from a base station, a first request to perform one or more measurements according to a QoE measurement configuration, wherein the request comprises an indication of the QoE measurement configuration, wherein the QoE measurement configuration is associated with a service type of a first application and at least one service subtype of the first application; initiating one or more QoE measurements according to the QoE measurement configuration; and transmitting a QoE measurement report comprising results of the one or more QoE measurements to the base station.

According to a second aspect, there is provided a method performed by a base station for initiating performance of Quality of Experience, QoE, measurements for a first application. The method comprises transmitting, to a wireless device, a first request to perform one or more measurements according to a QoE measurement configuration, wherein the request comprises an indication of the QoE measurement configuration, and wherein the QoE measurement configuration is associated with a service type of a first application and at least one service subtype of the first application; and receiving a QoE measurement report associated with the QoE measurement configuration.

According to a third aspect, there is provided a method performed by a network node for initiating performance of Quality of Experience, QoE, measurements for a first application. The method comprises transmitting to a base station, a set of QoE measurement configurations comprising a QoE measurement configuration, wherein the QoE measurement configuration is associated with a service type of the first application and at least one service subtype of the first application.

According to further aspects, apparatuses (wireless devices, base stations and network nodes) and computer program products corresponding to the above methods are also provided.

Certain embodiments may provide one or more of the following technical advantage(s). The embodiments described herein enable a multiplicity of QoE measurement configurations and associated QoE reporting for a one service type.

### BRIEF DESCRIPTION OF THE DRAWINGS

Some of the embodiments contemplated herein will now be described more fully with reference to the accompanying drawings, in which:

FIG. 1 is a signalling diagram showing UE capability transfer;

FIG. 2 is a signalling diagram showing application layer measurement reporting;

FIG. 3 is a schematic showing the system architecture view with 5GS appearing as TSN bridge;

FIG. 4 is a flow chart illustrating a method performed by a wireless device in accordance with some embodiments;

FIG. 5 is a flow chart illustrating a method performed by a base station in accordance with some embodiments;

FIG. 6 is a flow chart illustrating a method performed by a network node in accordance with some embodiments;

FIG. 7 shows a wireless network in accordance with some embodiments;

FIG. 8 shows a user equipment in accordance with some embodiments;

FIG. 9 shows a virtualization environment in accordance with some embodiments;

FIG. 10 shows a telecommunication network connected via an intermediate network to a host computer in accordance with some embodiments;

FIG. 11 shows a host computer communicating via a base station with a user equipment over a partially wireless connection in accordance with some embodiments;

FIG. 12 is a flow chart illustrating methods implemented in a communication system including a host computer, a base station and a user equipment in accordance with some embodiments;

FIG. 13 is a flow chart illustrating methods implemented in a communication system including a host computer, a base station and a user equipment in accordance with some embodiments;

FIG. 14 is a flow chart illustrating methods implemented in a communication system including a host computer, a base station and a user equipment in accordance with some embodiments;

FIG. 15 is a flow chart illustrating methods implemented in a communication system including a host computer, a base station and a user equipment in accordance with some embodiments;

FIG. 16 shows a virtualization apparatus in accordance with some embodiments;

FIG. 17 shows a virtualization apparatus in accordance with some embodiments; and

FIG. 18 shows a virtualization apparatus in accordance with some embodiments.

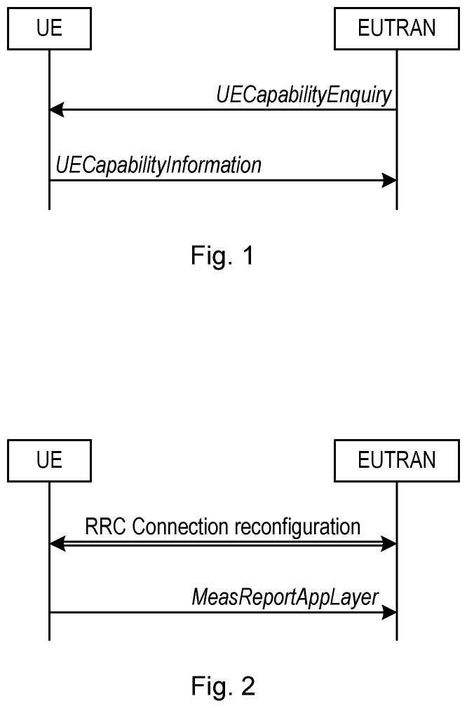

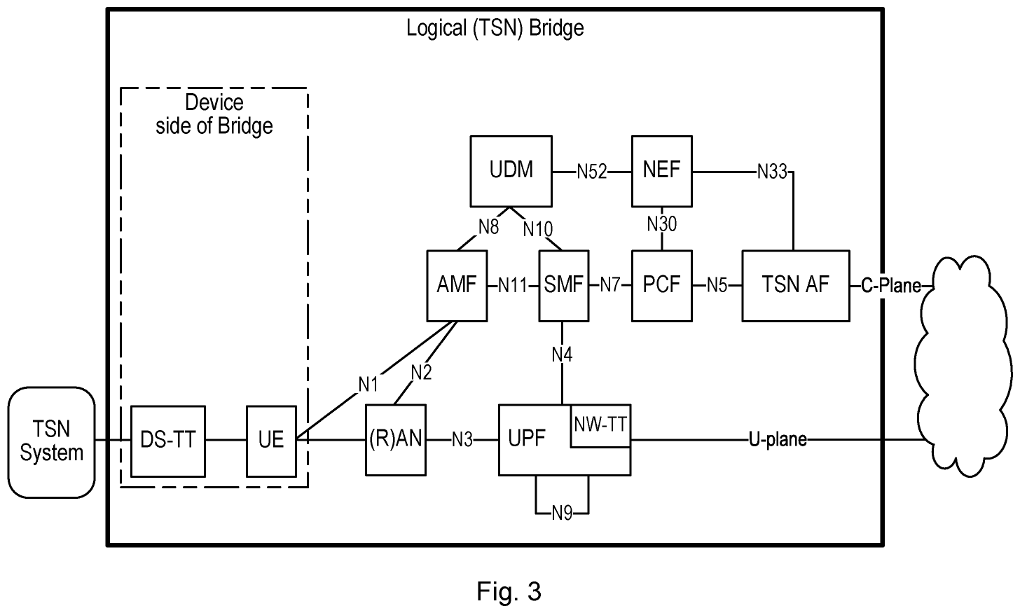

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The terms “UE”, “wireless device”, “terminal equipment”, “wireless terminal” and “terminal” are used herein interchangeably.

The terms “QoE measurement report”, “QoE report”, “measurement report” and “report” are used herein interchangeably.

The terms “QoE measurement configuration”, QoE measurement and reporting configuration”, “QoE configuration” and “application layer measurement configuration” are used interchangeably.

The terms “service” and “application” are used interchangeably.

The terms “service subtype”, “subservice type” and “subtype” are used interchangeably.

The terms “MCE” and “TCE” are used interchangeably.

For the proposed solution, the following is considered:
a RAN node or a base station may comprise any of the following: a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB.

In embodiments described herein, Time Sensitive Communication (TSC) and TSC services (e.g. applications using TSC) are frequently used as examples to illustrates various aspects of the proposed embodiments. It will however be appreciated that this is a choice merely based on suitability for the illustration and explanation of the embodiments, and that the embodiments would be equally applicable when other non-application specific aspects (e.g. aspects or properties that may be relevant for multiple different applications) are concerned, such as QoE aspects or metrics related to high reliability communication (e.g. applications requiring communication with extremely low data loss rate).

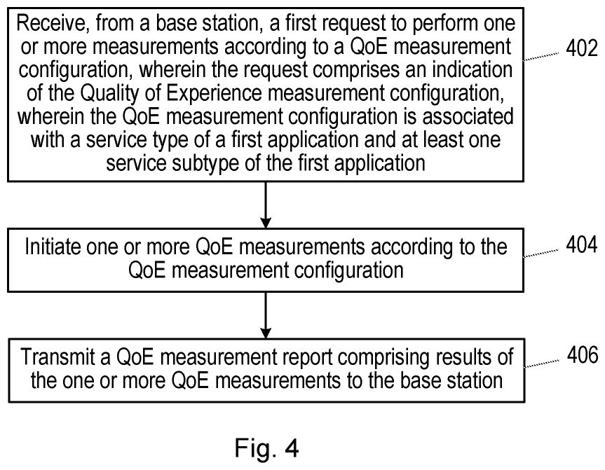

FIG. 4 illustrates a method, in accordance with some embodiments, performed by a wireless device for initiating performance of Quality of Experience, QoE, measurements for a first application.

FIG. 4 depicts a method in accordance with particular embodiments, the method begins at step 402 with receiving, from a base station, a first request to perform one or more measurements according to a QoE measurement configuration, wherein the request comprises an indication of the Quality of Experience measurement configuration, wherein the QoE measurement configuration is associated with a service type of a first application and at least one service subtype of the first application.

The indication of the QoE measurement configuration may comprise a unique QoE reference identifier. The QoE measurement configuration may be associated with a plurality of service types.

The service type of the first application and the at least one service subtype of the first application may be indicated in separate information elements or in a single information element. In some embodiments, the service type of the first application is associated with a first set of QoE metrics, and the at least one service subtype is associated with a second set of QoE metrics. In these embodiments, the QoE measurement configuration comprises both the first set of QoE metrics and the second set of QoE metrics. In some of these embodiments, the first set of QoE metrics is associated with a first set of QoE measurements and/or a first set of QoE reporting schemes; and the second set of QoE metrics is associated with a second set of QoE measurements and/or a second set of QoE reporting schemes.

Step 404 comprises initiating one or more QoE measurements according to the QoE measurement configuration.

Step 406 comprises transmitting a QoE measurement report comprising results of the one or more QoE measurements to the base station. In some embodiments, initiating one or more QoE measurements comprises transmitting the QoE measurement configuration to an application layer or an Application Programming Interface, API. The method of FIG. 4 can further comprise receiving the QoE measurement report from the application layer or API.

In some embodiments, the method of FIG. 4 further comprises receiving, from the base station, a second request to pause or release the QoE measurement configuration. The second request can comprise the indication of the QoE measurement configuration. The method can further comprise initiating pausing or releasing of the QoE measurement configuration.

In some embodiments, the method of FIG. 4 can further comprise providing user data; and forwarding the user data to a host computer via the transmission to the base station.

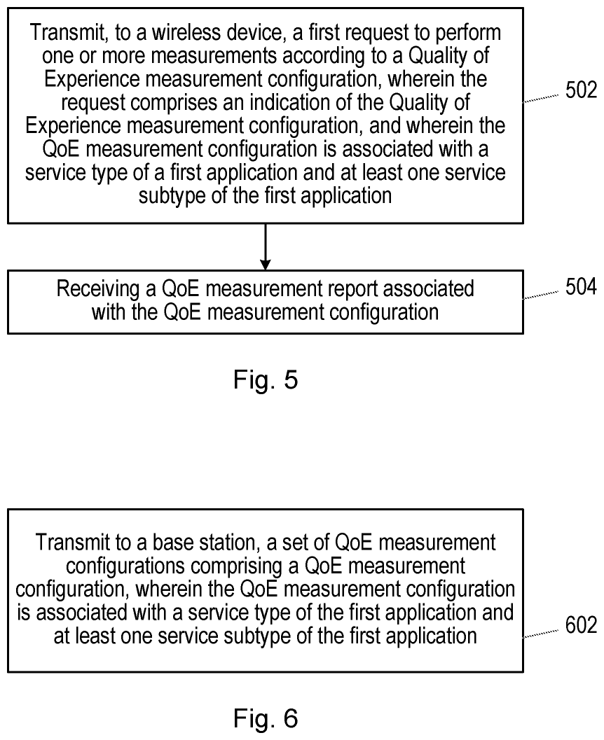

FIG. 5 illustrates a method performed by a base station for initiating performance of Quality of Experience, QoE, measurements for a first application.

FIG. 5 depicts a method in accordance with particular embodiments, the method begins at step 502 with transmitting, to a wireless device, a first request to perform one or more measurements according to a Quality of Experience measurement configuration, wherein the request comprises an indication of the Quality of Experience measurement configuration, and wherein the QoE measurement configuration is associated with a service type of a first application and at least one service subtype of the first application.

The method of FIG. 5 can further comprise transmitting the first request to a plurality of wireless devices. The indication of the QoE measurement configuration can comprise a unique QoE reference identifier.

In step 504 the method comprises receiving a QoE measurement report associated with the QoE measurement configuration.

The method of FIG. 5 can further comprise transmitting, to the wireless device, a second request to pause or release the QoE measurement configuration. In these embodiments, the second request comprises the indication of the QoE measurement configuration.

In some embodiments, the method can further comprises receiving, from a network node, a set of QoE measurement configurations comprising the QoE measurement configuration. In these embodiments, the method can comprise receiving, from the network node, an indication of an area scope in which the QoE measurement configuration is valid. In some of these embodiments, the method may comprise receiving, from the network node, an indication of one or more Measurement Collection Entities, MCEs, associated with the first application to which the base station should send the QoE report. The method can further comprise receiving, from the network node, information identifying the service type of the first application and information identifying the at least one service subtype of the first application. In these embodiments, the information identifying the service type of the first application and information identifying the at least one service subtype of the first application can form separate information elements or be comprised in a single information element.

In some embodiments, the QoE measurement configuration is associated with a plurality of service types. The service type of the first application may be associated with a first set of QoE metrics, and the at least one service subtype may be associated with a second set of QoE metrics. In these embodiments, the QoE measurement configuration comprises both the first set of QoE metrics and the second set of QoE metrics. The first set of QoE metrics may be associated with a first set of QoE measurements and/or a first set of QoE reporting schemes; and the second set of QoE metrics may be associated with a second set of QoE measurements and/or a second set of QoE reporting schemes.

In some embodiments, the method of FIG. 5 further comprises: obtaining user data; and forwarding the user data to a host computer or a wireless device.

FIG. 6 illustrates a method performed by a network node for initiating performance of Quality of Experience, QoE, measurements for a first application. The network node may comprise an OAM node or a core network node.

FIG. 6 depicts a method in accordance with particular embodiments, the method begins at step 602 with transmitting to a base station, a set of QoE measurement configurations comprising a QoE measurement configuration. The QoE measurement configuration is associated with a service type of the first application and at least one service subtype of the first application.

The method of FIG. 6 may further comprise a step of transmitting, to the base station, an indication of an area scope in which the QoE measurement configuration is valid. In some embodiments, the method comprises transmitting, to the base station, an indication of one or more Measurement Collection Entities, MCEs, associated with the first application to which the base station should send a QoE report associated with the QoE measurement configuration.

The method of FIG. 6 may further comprise a step of transmitting, to the base station, information identifying the service type of the first application and information identifying the at least one service subtype of the first application.

The information identifying the service type of the first application and information identifying the at least one service subtype of the first application can form separate information elements or be comprised in single information element.

The QoE measurement configuration may be associated with a plurality of service types. The service type of the first application may be associated with a first set of QoE metrics, and the at least one service subtype may be associated with a second set of QoE metrics. In these embodiments, the QoE measurement configuration comprises both the first set of QoE metrics and the second set of QoE metrics. In some of these embodiments, the first set of QoE metrics is associated with a first set of QoE measurements and/or a first set of QoE reporting schemes; and the second set of QoE metrics is associated with a second set of QoE measurements and/or a second set of QoE reporting schemes.

In general, some aspects of the embodiments may be said to comprise the ability to focus QoE measurement configurations on different aspects of a service or service type. One concept of embodiments described herein comprises a hierarchical description of an application (or service) comprising service types and subservice types (also referred to as service subtypes or just subtypes).

In some embodiments, conceptually—and possibly specification-wise—this concept may be considered to be similar to the type of class hierarchy used in object-oriented programming languages. A certain service (or application) may belong to a service type, but it may also belong to a subtype of this service type. A set of QoE metrics (and optionally QoE measurements and/or QoE measurement report types) may be specified/defined for the service type in general, while further QoE metrics (and optionally QoE measurements and/or QoE measurement report types) may be specified/defined specifically for the service subtype. A specific QoE measurement configuration pertaining to the service subtype may therefore comprise QoE metrics both from the service type level and the service subtype level.

In other words, for the methods described in FIGS. 4 to 6, the service type of the first application is associated with a first set of QoE metrics, and the at least one service subtype is associated with a second set of QoE metrics, wherein the QoE measurement configuration comprises both the first set of QoE metrics and the second set of QoE metrics. The first set of QoE metrics is associated with a first set of QoE metrics measurements and/or a first set of QoE reporting schemes; and the second set of QoE metrics is associated with a second set of QoE metrics measurements and/or a second set of QoE reporting schemes.

As an example, a first application, application 1 and a second application, application 2, may both be associated with a service type of a Time Sensitive Communication (TSC) service, while they, apart from that, have quite different properties and purposes. There may then be a set of QoE metrics (and possibly associated QoE measurements and/or QoE measurement reporting schemes) defined/specified for TSC services, which may be included in a QoE measurement configuration targeting either application 1 or application 2. In addition, there may be another set of QoE metrics (and possibly associated QoE measurements and/or QoE measurement reporting schemes) defined/specified for application 1, which may be included in a QoE measurement configuration targeting application 1, and yet another set of QoE metrics (and possibly associated QoE measurements and/or QoE measurement report types) defined/specified for application 2, which may be included in a QoE measurement configuration targeting application 2.

Therefore, the QoE metric “space” available for QoE measurement configurations targeting application 1 “inherits” the QoE metrics defined/specified for TSC services and adds QoE metrics specifically for application 1. The same principle may be used for application 2, and note that the specific QoE metrics for application 2 may overlap with the specific QoE metrics for application 1, e.g. some subtype specific QoE metrics (which are not included in the set of QoE metrics defined/specified on the TSC level) may be the same for application 1 and application 2.

This kind of inheritance principle may be used to enable a streamlined and coherent way to define/specify QoE metric “spaces” available for QoE measurement configurations targeting different service types, service subtypes or services/applications.

In the description above, two hierarchical levels were used, but this may be generalized to any number of hierarchical levels. For instance, as an example involving three levels, the top level may be the TSC service type, while the first subtype level may include e.g. periodic services and aperiodic services, or synchronous services and asynchronous services, and a second subtype level may include specific applications (or application types), e.g. associated with a certain sensor or actuator type or a certain machine or machine aspect in an industrial process. Each hierarchical level “inherits” the QoE metrics (and possibly associated QoE measurements and/or QoE measurement reporting schemes) defined/specified for the higher hierarchical level(s). It will therefore be appreciated that the QoE measurement configuration of steps 402, 502 and 503 may be associated with a plurality of service subtypes, where there is three or more hierarchical levels.

The concept of inheritance may be extended to allow a service subtype to inherit properties, e.g. sets of QoE metrics (and possibly associated QoE measurements and/or QoE measurement report types) from more than one higher level service type or subtype. In other words, the QoE measurement configuration may be associated with a plurality of service types.

For example, a certain application may belong to the TSC service type, but may also belong to the “high reliability” service type or “data loss tolerant” service type (where the “high reliability” and “data loss tolerant” service types may be at the same level in the hierarchy as the TSC service type). That is, if the application belongs both to the TSC service type and the “high reliability” service type, the QoE metrics “space” available for QoE measurement configurations targeting the application may include the union of the set of QoE metrics defined/specified for the TSC service type and set of QoE metrics defined/specified for the “high reliability” service type, as well as additional QoE metrics defined/specified specifically for that particular application (and also the QoE metrics defined/specified for any hierarchical service subtype level that may be defined/specified to be in-between the TSC/“high reliability” level and application).

The base station (performing the method of FIG. 5) may receive a from network node (e.g. a network node performing the method of FIG. 6), a set of QoE measurement configurations comprising the QoE measurement configuration. It will be appreciated that the set of QoE measurement configurations comprise a plurality of QoE measurement configurations that may relate to a single application or multiple applications. Similarly a plurality of measurement configurations may indicated to a single wireless device (e.g. in the first request), or may be indicated to a plurality of wireless devices (e.g. the first request may be transmitted to a plurality of wireless devices). In particular, any QoE measurement configuration relating to a particular application may be indicated to a wireless device operating that application. As previously mentioned, a QoE measurement configuration is associated with a service type of an application and at least one service subtype of the application.

A service subtype indicates a variant of a QoE measurement configuration which configures QoE measurements to be performed/collected, and an associated variant of QoE report for reporting the collected QoE measurement data, wherein the QoE measurement configuration is to be used by one or multiple UEs for one application and wherein the type of the application is indicated by service type. Distinct service subtypes can be used to indicate distinct variants of QoE measurements to be collected and associated QoE reports to be reported (e.g. transferred from the UE to the network) by one or multiple UEs for one application wherein the application is indicated by service type and the service subtypes.

A base station (e.g. performing the method of FIG. 5) may also receive an indication of an area scope where the QoE measurement configuration(s) are valid from the network node (e.g. performing the method of FIG. 6).

A base station (e.g. performing the method of FIG. 5) may also receive an indication of one or more MCEs towards which the base station should send the QoE measurements reports for the concerned application(s). For example, the base station may receiving a list of QoE measurement configurations related to two applications (application 1 and application 2) and the indication of two different MCEs so that QoE reports for application 1 will be sent from the base station to the MCE1, and QoE reports for application 2 will be sent from the RAN node to the MCE2. In some examples, the QoE measurement configuration related to application 1 may be used to configure a first wireless terminal, UE1, and the QoE measurement configuration related to application 2 may be used to configure a second wireless terminal, UE2. In some examples, the QoE measurement configuration related to application 1 and QoE measurement configuration related to application 2 may be used to configure the same wireless terminal, UE1.

The base station may also receive, from the network node, information identifying the service type of the first application and information identifying the at least one service subtype of the first application. In some examples, the information identifying the service type of the first application and information identifying the at least one service subtype of the first application form separate information elements. In some examples, the information identifying the service type of the first application and information identifying the at least one service subtype of the first application are comprised in single information element.

A service type may comprise e.g. legacy service types “streaming” and “mtsi”, as well as other service types, e.g. related to time sensitive communications or non-3gpp types of applications. A service type may relate to an aspect of the quality of the service provided, e.g. time sensitive, high reliability, data loss tolerant.

The service subtype may comprise for example, “subtype1” or “subtype2” to indicate streaming of “subtype1” or streaming of “subtype2”, where “subtype1” and “subtype2” indicate different variants of the QoE metrics defined for a service type “streaming”.

The indication of the QoE measurement configuration may comprise a unique QoE measurement identifier, e.g. a QoE reference ID, to uniquely associate the QoE measurement configuration to a given service type and to a given service subtype, and to enable referencing an individual QoE measurement configurations or a set of measurement configuration(s), wherein the QoE measurement identifier may be associated with an individual QoE measurement configuration or a set of QoE measurement configuration(s)

The first request may comprise an RRCReconfiguration message (or alike) to setup, or resume one or multiple QoE measurement configurations, wherein one QoE measurement configuration is associated to a service type and a service subtype, and wherein one unique QoE measurement identifier, e.g. a QoE reference ID, is sent to the UE to uniquely identify such a QoE measurement configuration. It will also be appreciated that the base station may transmit a second request to the wireless device to pause or release the QoE measurement configuration.

In some examples the QoE measurement configuration is received at the base station from a OAM node or 5GC node. However, in some examples, the QoE measurement configuration can be prepared by the base station, e.g. according to a lightweight QoE measurement concept. Lightweight QoE is a concept introduced for QoE management in NR, where the RAN can be responsible to prepare and activate QoE measurements independently of the legacy QoE configuration assembled and activated by OAM. The Lightweight QoE can be used for all services, including those for which no QoE metric is standardized by SA4. The UE is requested to provide a Lightweight QoE score (or Lightweight QoE metric) delivered to the RAN as a separate IE visible to the RAN.

Lightweight QoE metrics may include at least an overall QoE score, that may be represented as e.g.:
A numeric value on a scale between 0 to x, or
An objective qualitative representation (“good QoE”, “moderate QoE”, “bad QoE”), or
A binary flag

Step 504 may comprise an RRC MeasurementReport message(s) (or alike) containing the QoE measurement report(s) for the service type(s) and subtype(s). In some examples, the RRC measurement report may comprise a unique QoE measurement identifier, e.g. a QoE reference ID, that matches the unique QoE measurement identifier sent from the base station to the wireless device in step 502.

The QoE measurement reports can be related to QoE configurations that the base station received from OAM or 5GC or the QoE measurement reports can be related to QoE configurations prepared according to the lightweight QoE measurement concept.

3GPP has defined a list of metrics for several services (e.g. MTSI, DASH etc.). As mentioned earlier, for a given service subtype, it may not be necessary to measure all the metrics that are standardized for the service type (i.e. “partial inheritance” is possible). In order for the UE to be able to understand which exact measurements to execute, several options are possible:

The OAM or core network node sends an explicit list of metrics to the UE, which is a subset of a list of metrics that are defined. This approach may not be standard compliant, since it may not comply to the mandatory presence of some or all of the metrics in the configuration file (since some metrics are not necessary to measure, if they do not pertain to the service subtype).

Alternatively, in a QoE measurement configuration file pertaining to a service subtype, the OAM or core network node may send the entire legacy standardized list of metrics, and an indicator (e.g. bit string with 1s and 0s, or a pointer, or an explicit indication) from which the UE may be able to infer which of the QoE metrics in the list it should measure and which to ignore. For example, if a bit string is used, each bit in the bit string refers to one metric in the legacy list. So, if the e.g. first bit in the string=“1”, this may indicate to the UE that the first metric in the list is to be measured etc.

Referring to FIG. 4, the first request may comprise a RRCReconfiguration message or alike to setup, resume one or multiple QoE measurement configurations, wherein one QoE measurement configuration is associated to a service type and a service subtype and uniquely identified, e.g. using a QoE reference ID. I some examples, the wireless device receives, from the base station, a second request to pause or release the QoE measurement configuration, wherein the second request comprises the indication of the QoE measurement configuration. The wireless device may then initiate pausing or releasing of the QoE measurement configuration.

The wireless device may be configured to initiate the one or more QoE measurements as in step 404, by transmitting the QoE measurement configuration to an application layer (e.g. via AT commands) or an Application Programming Interface, API. The wireless device may also include the unique QoE reference identifier. The wireless device may then receive the QoE measurement report from the application layer (e.g. via AT commands) or API.

The wireless device then transmits the QoE measurement report(s) related to the application(s) to the base station. The wireless device may transmit to the base station the unique QoE reference ID, matching the unique QoE reference identifier sent from the RAN node to the UE during the QoE configuration phase.

### Example of Implementation

### Next Generation Application Protocol (NGAP)

An example of implementation is provided below for NGAP (TS 38.413), where the underlined text relates to the present embodiments.

### 9.3.1.xxx UE Application Layer Measurement Configuration

The information element (IE) defines configuration information for the QoE Measurement Collection (QMC) function.

| IE/Group | | | IE type and | Semantics | | Assigned |
|---|---|---|---|---|---|---|
| Name | Presence | Range | reference | description | Criticality | Criticality |
| Container for | M | | Octet string | Indicates | — | |
| application | | | (1 . . . 1000) | application | | |
| layer | | | | layer | | |
| measurement | | | | measurement | | |
| configuration | | | | configuration. | | |
| CHOICE Area | M | | | | — | |
| Scope of QMC | | | | | | |
| >Cell based | | | | | | |
| >>Cell ID | | 1 . . . | | | | |
| List for | | <maxnoofCellIDforQMC> | | | | |
| QMC | | | | | | |
| >>>NR | M | | 9.3.1.7 | | — | |
| CGI | | | | | | |
| >TA based | | | | | | |
| >>TA List | | 1 . . . | | | | |
| for QMC | | <maxnoofTAforQMC> | | | | |
| >>>TAC | M | | 9.3.3.10 | The TAI is | — | |
| | | | | derived using | | |
| | | | | the current | | |
| | | | | serving PLMN. | | |
| >TAI based | | | | | — | |
| >>TAI List | | 1 . . . | | | — | |
| for QMC | | <maxnoofTAforQMC> | | | | |
| >>>TAI | M | | 9.3.3.11 | | — | |
| >PLMN area | | | | | | |
| based | | | | | | |
| >>PLMN | | 1 . . . | | | | |
| List for | | <maxnoofPLMNforQMC> | | | | |
| QMC | | | | | | |
| >>>PLMN | M | | 9.3.3.5 | | — | |
| Identity | | | | | | |
| Service Type | M | | ENUMERATED | This IE | — | |
| | | | (QMC for | indicates the | | |
| | | | streaming service, | service type of | | |
| | | | QMC for MTSI | UE application | | |
| | | | service,‘tsc-ia’, | layer | | |
| | | | ‘non-3GPP’ . . .) | measurements. | | |
| Service | | 0 . . . | | | | |
| Subtype List | | <maxnoofServiceSubtype> | | | | |
| >Service | | | Octet string | Indicates | — | |
| Subtype Item | | | (1 . . . 1000) | the service | | |
| | | | | subtype. | | |

| Range bound | Explanation |
|---|---|
| maxnoofCellIDforQMC | Maximum no. of Cell ID subject for QMC |
| | scope. Value is 32. |
| maxnoofTAforQMC | Maximum no. of TA subject for QMC scope. |
| | Value is 8. |
| maxnoofPLMNforQMC | Maximum no. of PLMNs in the PLMN list for |
| | QMC scope. Value is 16. |
| maxnoofServiceSubtype | Maximum no. of Service Subtype supported. |
| | Value is 32. |

In line with the embodiments described herein, one or more new Service Type ENUMERATED value(s) that may be added may be more general than the existing Service Type values, which target a specific application (e.g. TMSI) or a narrow range of applications (streaming applications), e.g. “QMC for TSC service”. This may then serve to make full use of the subtyping concept (possibly using the above described “inheritance” principle). Together with such more generic, or broader, Service Type indications, service subtypes could be used to indicate specific applications within the generic/broad service type (this is also what is illustrated in the modified NGAP standard specification text above).

A motivation for the service subtype indications is that the network may not be interested in receiving QoE measurement results pertaining to all applications of a more general Service Type, but rather QoE measurement results pertaining to one or more certain application(s) of the general Service Type.

Taking a generic service type “QMC for TSC service” as an example to illustrate this, applications using TSC may be diverse, e.g. comprising a range of applications for which very different QoE metrics may be suitable (in addition to metrics specifically targeting TSC aspects). Furthermore, the network may not be interested in receiving QoE measurement results pertaining to all applications using TSC, but only a single application or a set of applications. For these reasons, more fine granular application/service type indications may be an interesting alternative, e.g. in the form of service subtype indications. With the TSC examples, TSC service subtypes could be (using ENUMERATED values similar to the Service Type IE as an example) ENUMERATED values like “QMC for TSC application 1”, “QMC for TSC application 2”, “QMC for TSC application 3”, etc. (where these example ENUMERATED values serve to illustrate the principle, while actually specified service subtype ENUMERATED values may be more descriptive as to which application/service type they indicate).

Note that the RRC layer in the UE takes the indicated service type, e.g. the RRC serviceType IE (e.g. serviceType-r15 in the RRC specification for LTE, e.g. 3GPP TS 36.331 version 16.2.0), into account when forwarding the QoE measurement configuration (e.g. the content of the measConfigAppLayerContainer IE) to the upper layers (e.g. the application layer). This may be extended so that the RRC layer in the UE also takes the service subtype into account.

Note that the same application or service subtype could be a service subtype for more than one (generic/broad) service type. When this is the case, one option is to use the same service subtype value irrespective of which service type it pertains to in the particular case. Another option is to use different service subtype values for an application or service subtype, depending on which service type it pertains to in the particular case (e.g. application X may have service subtype value 1 when it is indicated as a service subtype to the TSC service type, but have service subtype value 2 when it is indicated as a service subtype to a high reliability service type). The indicated service subtype may indicate which QoE metrics that are available for measurement and QoE measurement configuration.

Another approach could be to let each service subtype be a service type of its own, e.g. it may have a Service Type ENUMERATED value in the above modified NGAP standard specification text. This may effectively indicate both the service type and the service subtype in the same information element, e.g. in the service type information element.

Continuing with the TSC services as the example, a Service Type ENUMERATED value could be introduced for each TSC application (optionally replacing the general “QMC for TSC-IA service” Service Type value), e.g. “QMC for TSC-IA service 1”, “QMC for TSC-IA service 2”, “QMC for TSC-IA service 3” etc. Note again that the RRC layer in the UE takes the serviceType IE (e.g. the serviceType-r15 parameter in 3GPP TS 36.331) into account when forwarding the QoE measurement configuration (e.g. the content of the measConfigAppLayerContainer IE) to the upper layers (e.g. the application layer). If the general “QMC for TSC service” Service Type ENUMERATED value is kept in parallel with the application/service specific Service Type ENUMERATED values, then the general “QMC for TSC service” value could be used for a case where the QoE measurement configuration is TSC related, but agnostic to the specific application type, and where the application type agnostic “QMC for TSC service” Service Type ENUMERATED value may indicate that TSC related QoE metrics should be measured for all TSC related applications/services (or service subtypes).

As an option, multiple Service Type ENUMERATED values could be introduced for the same application/service, depending on which type of QoE measurement configuration that is intended. For instance, an application X which uses TSC may have the Service Type value “QMC for TSC service X” when the intention is to measure QoE metrics related to TSC, while the same application X may have the Service Type value “QMC for service X” when some other application-tailored QoE measurement configuration is intended. To these Service Type values associated with the same application/service could potentially be added even more Service Type values, depending on the properties of the application/service, e.g. “QMC for high reliability service X”, indicating that the purpose of the QoE measurement configuration is to collect QoE measurement data related to communication reliability aspects. If multiple types of QoE measurements are desired (e.g. TSC related, high reliability related and “regular” application/service specific), then it may be possible to indicate multiple Service Type values for the same QoE measurement configuration.

Another alternative may be to configure a separate QoE measurement configuration in parallel for the same UE, where each QoE measurement configuration may have a different Service Type value, indicating different QoE aspects (e.g. different QoE metrics) to be measured. As yet another alternative, one or more additional Service Type values could be introduced to cover combinations of aspects related to properties of the same application/service. For instance, for an application/service using TSC and high reliability communication, a Service Type value “QMC for all QoE aspects of service X” could be used to indicate that all relevant QoE aspects should be measured, e.g. TSC related QoE metrics, QoE metrics related to high reliability communication and QoE metrics specified for “regular” QoE measurements for the concerned application/service (e.g. service X). In general, in all of the above, the indicated Service Type value may indicate which QoE metrics that are available for measurement and QoE measurement configuration.

As yet another related example, the QoE measurement configuration information could indicate whether, for a TSC related application/service type, only regular (non-TSC related) QoE metrics, only TSC related QoE metrics or both regular and TSC related QoE metrics should be measured. One way of indicating this could be to have three Service Type ENUMERATED values for a single TSC related application/service type, each indicating one of these three options, e.g. “QMC for regular service X”, “QMC for TSC service X” and “QMC for regular and TSC service X”. As a variation of this, the case where only TSC related QoE metrics could be measured could be agnostic to the application/service type, as long as the application/service type uses TSC, e.g. TSC related QoE metrics should be measured for all TSC related applications. For the case where such an application/service type agnostic QoE measurement configuration for TSC related QoE metrics measurements is provided, the generic “QMC for TSC service” Service Type ENUMERATED value suggested in the example above could be used, while application specific ENUMERATED values may be used if the network wants only regular (non-TSC related) QoE metrics or both regular (non-TSC related) and TSC related QoE metrics to be measured.

As yet another option, TSC QoE measurements could be considered to be a fixed or configurable set of QoE metrics or QoE measurements, which could be added to separately to any service type. This could be realized in the form of one or more new parameter(s) e.g. to be combined with the Service Type value. Another way to realize it may be to make TSC QoE measurements a service subtype, in which case the service subtype concept may be used in a different way than previously described. This could of course be generalized to any other non-application specific aspect or property than TSC, such as QoE measurements related to high reliability communication, e.g. communication reliability aspects such as data loss rate.

As yet another option, the Service Type IE may only indicate the concerned application/service type, while a new parameter/IE (e.g. a Boolean parameter called “Collect TSC related QoE metrics”) may be introduced to indicate whether TSC related QoE metrics (in addition to regular, possibly application specific, QoE metrics) should be measured for a TSC related application. This could of course be generalized to other aspects or property areas than TSC, e.g. high reliability communication (e.g. communication requiring extremely low data loss rates).

### RRC

An example of implementation is provided below for RRC (TS 38.331), where the underlined text relates to the present embodiments.

MeasConfigAppLayer-r17 ::= SEQUENCE {

| | | |
|---|---|---|
| measConfigAppLayerContainer-r17 | OCTET STRING (SIZE(1..1000)) | OPTIONAL, -- Need |

ON

| | |
|---|---|
| serviceType-r17 ServiceType-r17 | OPTIONAL, -- Need ON |

serviceSubtype-r17 ServiceSubtype-r17 OPTIONAL, -- Need ON

| | |
|---|---|
| qoe-Reference-r17 QoE-Reference-r17 | OPTIONAL, -- Need ON |
| withinArea-r17 ENUMERATED {inside, outside} | OPTIONAL, -- Need ON |
| temporaryStopQoE-r17 | BOOLEAN, |
| restartQoE-r17 | BOOLEAN |

}
MeasReleaseAppLayer-r17 ::= SEQUENCE {

| | |
|---|---|
| serviceType-r17 ServiceType-r17 | OPTIONAL, -- Need ON |
| qoe-Reference-r17 QoE-Reference-r17 | OPTIONAL -- Need ON |

```
  serviceSubtype-r17 ServiceSubtype-r17 OPTIONAL, -- Need ON
}
ServiceSubtype-r17 ::= SEQUENCE {
  serviceSubtype-r17 OCTET STRING (SIZE(1..1000))
...
}
```

Similar principles that were described above in the context of NGAP may be used also for the RRC layer and the RRC specification, e.g. in terms of Service Type ENUMERATED values and/or service subtype values (e.g. ENUMERATED values). In the RRC specification, the IE corresponding to the NGAP Service Type IE may be called serviceType-r17 for NR in the coming release 17 of the 3GPP standard, in line with the corresponding IE for LTE, which is called serviceType-r15 (and included in the measConfigAppLayer-r15 IE). In both cases (as for other IEs with “-rX” or “-rXX” postfix), the postfix is often skipped, leaving serviceType as the name that is often used to refer to the IE in running text (albeit not in the ASN.1 code). Like the Service Type IE in NGAP, the serviceType IE in the RRC specification for LTE has the type ENUMERATED and this can be assumed to be the case also for NR in 3GPP release 17.

With TSC services as an example, a generic serviceType ENUMERATED value for TSC services could be e.g. “tsc”. And one or more new IEs could be introduced to indicate service subtype values, e.g. serviceSubtypeList (or serviceSubtypeList-r17) and/or serviceSubtype (or serviceSubtype-r17), where the serviceSubtypeList IE may contain a list of serviceSubtype IEs and the serviceSubtype IE e.g. could be of type ENUMERATED.

As described above for the case of NGAP, another approach could be to let each service subtype be a service type of its own, e.g. it may have a serviceType ENUMERATED value, e.g. in the measConfigAppLayerContainer IE. Continuing with the TSC services as the example, a serviceType ENUMERATED value could be introduced for each TSC application (optionally replacing the general “tsc-ia” serviceType value), e.g. “tsc-ia_service-1”, “tsc-ia_service-2”, “tsc-ia_service-3” etc. Note again that the RRC layer in the UE takes the serviceType IE (e.g. the serviceType-r15 parameter in 3GPP TS 36.331) into account when forwarding the QoE measurement configuration (e.g. the content of the measConfigAppLayerContainer IE) to the upper layers (e.g. the application layer). If the general “tsc-ia” serviceType ENUMERATED value is kept in parallel with the application/service specific serviceType ENUMERATED values, then the general “tsc-ia” value could be used for a case where the QoE measurement configuration is TSC related, but agnostic to the specific application/service type, and where the application/service type agnostic “tsc-ia” serviceType ENUMERATED value may indicate that TSC related QoE metrics should be measured for all TSC related applications/services (or service subtypes).

Similar to what was described above in conjunction with the NGAP example, multiple serviceType ENUMERATED values could be introduced per TSC related application, e.g. “service-X” (indicating regular QoE measurements suitable or tailored for service X) and “tsc_service-X” (indicating TSC related QoE measurements for service X). Or for further diversified indication of QoE metrics to be measured, serviceType ENUMERATED values like “reg_service-X”, “tsc_service-X” and “reg_tsc_service-X” could be used, where “reg_service-X” may indicate “regular” QoE measurements suitable or tailored for service X, “tsc_service-X” may indicate TSC related QoE measurements for service X, and “reg_tsc_service-X” may indicate that both “regular” QoE measurements suitable or tailored for service X and TSC related QoE measurements for service X should be performed.

Other options and alternatives related to service types, QoE aspects or QoE areas, multiple service types, combinations of service types, etc., as described above in conjunction with the NGAP example could also be reflected in the corresponding parameters at the RRC level and in the RRC standard specification.

An example of implementation is provided below for the AT commands (3GPP TS 27.007), which are used for communication between the RRC layer and the application layer in the UE, where the underlined text pertain to the embodiments.

### AT Commands

### 8.78 Application Level Measurement Configuration +CAPPLEVMC

TABLE 8.78-1
+CAPPLEVMC parameter command syntax

| Command | Possible response(s) |
|---|---|
| +CAPPLEVMC=[<n>] | +CME ERROR: <err> |
| +CAPPLEVMC? | +CAPPLEVMC: <n> |
| +CAPPLEVMC=? | +CAPPLEVMC: (list of supported <n>s) |

### Description

This command allows control of the application level measurement configuration according to 3GPP TS 25.331 [74] and 3GPP TS 36.331 [86] and 3GPP TS 38.331[xx]. The set command controls the presentation of the unsolicited result code +CAPPLEVMC: <app-meas_service_type>,<app-meas_service_subtype>,<start-stop_reporting>[,<app-meas_config_file_length>,<app-meas_config-file>] providing data for the configuration. Refer subclause 9.2 for possible <err> values.
Read command returns the current value of <n>.
Test command returns values supported as a compound value.

### Defined Values

<n>: integer type. Disable and enable presentation of the unsolicited result code +CAPPLEVMC to the TE.
0 Disable presentation of the unsolicited result code
1 Enable presentation of the unsolicited result code
   <app-meas_service_type>: integer type. Contains the indication of what application that is target for the application level measurement configuration.
1 QoE measurement collection for streaming services
2 QoE measurement collection for MTSI services
   <app-meas_service_subtype>: string of octets. Contains the indication of the application subtype that is the target for the application level measurement configuration.
<start-stop_reporting>: integer type. Indicates the start and stop of the application level measurement reporting for the application indicated by the <app-meas_service_type>.
   0 start the application level measurement reporting
   1 stop the application level measurement reporting
<app-meas_config_file_length>: integer type. Indicates the number of octets of the <app-meas_config-file> parameter.
<app-meas_config-file>: string of octets. Contains the application level measurement configuration file for the application indicated by the <app-meas_service_type> and <app-meas_service_subtype_id>. The parameter shall not be subject to conventional character conversion as per +CSCS.

In the above AT command example, the TSN-IA service indication (in the indication of service type for which QoE measurements should be performed) could be replaced/extended/diversified in the same way as described above in conjunction with the NGAP and RRC examples in sections 0 and 0.

### Application Level Measurement Report +CAPPLEVMR

TABLE 8.79-1
+CAPPLEVMR action command syntax

| Command | Possible response(s) |
|---|---|
| +CAPPLEVMR=<app-meas_service_type>,<app- | +CME ERROR: < err> |
| meas_service_subtype>,<app-meas_report_length>,<app- | |
| meas_report> | |
| +CAPPLEVMR=? | |

### Description

This command allows the MT to provide the application level measurement report according to 3GPP TS 25.331 [74] and 3GPP TS 36.331 [86] and 3GPP TS 38.331[xx]. Refer subclause 9.2 for possible <err> values.

### Defined Values

<app_meas_service_type>: integer type. Contains the indication of what application that is providing the application level measurement report.
   1 QoE measurement collection for streaming services
   2 QoE measurement collection for MTSI services
      <app-meas_service_subtype>: string of octets. Contains the indication of the application subtype that is the target for the application level measurement configuration.
<app-meas_report_length>: integer type. Indicates the number of octets of the <app-meas_report> parameter.
<app-meas_report>: string of octets. Contains the application level measurement configuration file for the application indicated by the <app-meas_service_type>. The parameter shall not be subject to conventional character conversion as per +CSCS.

In the above AT command example, the TSN-IA service indication (in the indication of service type for which QoE measurement results are reported) could be replaced/extended/diversified in a similar way as described above in conjunction with the NGAP and RRC examples above.

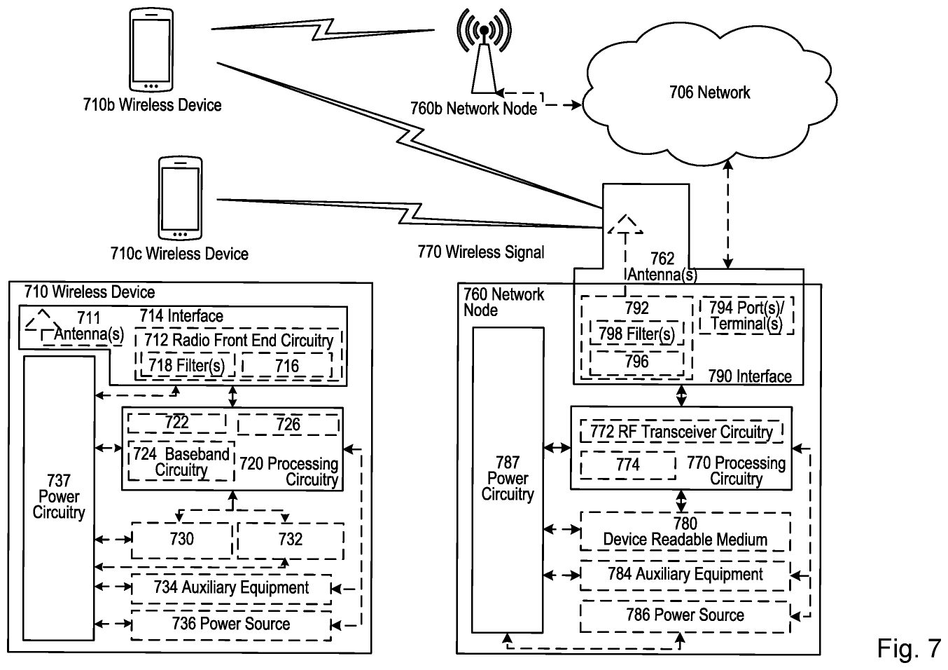

FIG. 7 shows a wireless network in accordance with some embodiments.

Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 706, network nodes 760 and 760b, and WDs 710, 710b, and 710c. In practice, a wireless network may further include any additional elements suitable to support communication between wireless devices or between a wireless device and another communication device, such as a landline telephone, a service provider, or any other network node or end device. Of the illustrated components, network node 760 and wireless device (WD) 710 are depicted with additional detail. The wireless network may provide communication and other types of services to one or more wireless devices to facilitate the wireless devices' access to and/or use of the services provided by, or via, the wireless network.

The wireless device 710 may be configured to perform the method as described with reference to FIG. 4. The network node 760 may be configured to perform the method as described with reference to FIG. 5.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 760 and WD 710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 760 includes processing circuitry 770, device readable medium 780, interface 790, auxiliary equipment 784, power source 786, power circuitry 787, and antenna 762. Although network node 760 illustrated in the example wireless network of FIG. 7 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 760 are depicted as single boxes located within a larger box, or nested within multiple boxes, in practice, a network node may comprise multiple different physical components that make up a single illustrated component (e.g., device readable medium 780 may comprise multiple separate hard drives as well as multiple RAM modules).

Similarly, network node 760 may be composed of multiple physically separate components (e.g., a NodeB component and a RNC component, or a BTS component and a BSC component, etc.), which may each have their own respective components. In certain scenarios in which network node 760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 760 may be configured to support multiple radio access technologies (RATs). In such embodiments, some components may be duplicated (e.g., separate device readable medium 780 for the different RATs) and some components may be reused (e.g., the same antenna 762 may be shared by the RATs). Network node 760 may also include multiple sets of the various illustrated components for different wireless technologies integrated into network node 760, such as, for example, GSM, WCDMA, LTE, NR, WiFi, or Bluetooth wireless technologies. These wireless technologies may be integrated into the same or different chip or set of chips and other components within network node 760.

Processing circuitry 770 is configured to perform any determining, calculating, or similar operations (e.g., certain obtaining operations) described herein as being provided by a network node. These operations performed by processing circuitry 770 may include processing information obtained by processing circuitry 770 by, for example, converting the obtained information into other information, comparing the obtained information or converted information to information stored in the network node, and/or performing one or more operations based on the obtained information or converted information, and as a result of said processing making a determination.

Processing circuitry 770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 760 components, such as device readable medium 780, network node 760 functionality. For example, processing circuitry 770 may execute instructions stored in device readable medium 780 or in memory within processing circuitry 770. Such functionality may include providing any of the various wireless features, functions, or benefits discussed herein. In some embodiments, processing circuitry 770 may include a system on a chip (SOC).

In some embodiments, processing circuitry 770 may include one or more of radio frequency (RF) transceiver circuitry 772 and baseband processing circuitry 774. In some embodiments, radio frequency (RF) transceiver circuitry 772 and baseband processing circuitry 774 may be on separate chips (or sets of chips), boards, or units, such as radio units and digital units. In alternative embodiments, part or all of RF transceiver circuitry 772 and baseband processing circuitry 774 may be on the same chip or set of chips, boards, or units

In certain embodiments, some or all of the functionality described herein as being provided by a network node, base station, eNB or other such network device may be performed by processing circuitry 770 executing instructions stored on device readable medium 780 or memory within processing circuitry 770. In alternative embodiments, some or all of the functionality may be provided by processing circuitry 770 without executing instructions stored on a separate or discrete device readable medium, such as in a hard-wired manner. In any of those embodiments, whether executing instructions stored on a device readable storage medium or not, processing circuitry 770 can be configured to perform the described functionality. The benefits provided by such functionality are not limited to processing circuitry 770 alone or to other components of network node 760, but are enjoyed by network node 760 as a whole, and/or by end users and the wireless network generally.

Device readable medium 780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 770. Device readable medium 780 may store any suitable instructions, data or information, including a computer program, software, an application including one or more of logic, rules, code, tables, etc. and/or other instructions capable of being executed by processing circuitry 770 and, utilized by network node 760. Device readable medium 780 may be used to store any calculations made by processing circuitry 770 and/or any data received via interface 790. In some embodiments, processing circuitry 770 and device readable medium 780 may be considered to be integrated.

Interface 790 is used in the wired or wireless communication of signalling and/or data between network node 760, network 706, and/or WDs 710. As illustrated, interface 790 comprises port(s)/terminal(s) 794 to send and receive data, for example to and from network 706 over a wired connection. Interface 790 also includes radio front end circuitry 792 that may be coupled to, or in certain embodiments a part of, antenna 762. Radio front end circuitry 792 comprises filters 798 and amplifiers 796. Radio front end circuitry 792 may be connected to antenna 762 and processing circuitry 770. Radio front end circuitry may be configured to condition signals communicated between antenna 762 and processing circuitry 770. Radio front end circuitry 792 may receive digital data that is to be sent out to other network nodes or WDs via a wireless connection. Radio front end circuitry 792 may convert the digital data into a radio signal having the appropriate channel and bandwidth parameters using a combination of filters 798 and/or amplifiers 796. The radio signal may then be transmitted via antenna 762. Similarly, when receiving data, antenna 762 may collect radio signals which are then converted into digital data by radio front end circuitry 792. The digital data may be passed to processing circuitry 770. In other embodiments, the interface may comprise different components and/or different combinations of components.

In certain alternative embodiments, network node 760 may not include separate radio front end circuitry 792, instead, processing circuitry 770 may comprise radio front end circuitry and may be connected to antenna 762 without separate radio front end circuitry 792. Similarly, in some embodiments, all or some of RF transceiver circuitry 772 may be considered a part of interface 790. In still other embodiments, interface 790 may include one or more ports or terminals 794, radio front end circuitry 792, and RF transceiver circuitry 772, as part of a radio unit (not shown), and interface 790 may communicate with baseband processing circuitry 774, which is part of a digital unit (not shown).

Antenna 762 may include one or more antennas, or antenna arrays, configured to send and/or receive wireless signals. Antenna 762 may be coupled to radio front end circuitry 790 and may be any type of antenna capable of transmitting and receiving data and/or signals wirelessly. In some embodiments, antenna 762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 762 may be separate from network node 760 and may be connectable to network node 760 through an interface or port.

Antenna 762, interface 790, and/or processing circuitry 770 may be configured to perform any receiving operations and/or certain obtaining operations described herein as being performed by a network node. Any information, data and/or signals may be received from a wireless device, another network node and/or any other network equipment. Similarly, antenna 762, interface 790, and/or processing circuitry 770 may be configured to perform any transmitting operations described herein as being performed by a network node. Any information, data and/or signals may be transmitted to a wireless device, another network node and/or any other network equipment.

Power circuitry 787 may comprise, or be coupled to, power management circuitry and is configured to supply the components of network node 760 with power for performing the functionality described herein. Power circuitry 787 may receive power from power source 786. Power source 786 and/or power circuitry 787 may be configured to provide power to the various components of network node 760 in a form suitable for the respective components (e.g., at a voltage and current level needed for each respective component). Power source 786 may either be included in, or external to, power circuitry 787 and/or network node 760. For example, network node 760 may be connectable to an external power source (e.g., an electricity outlet) via an input circuitry or interface such as an electrical cable, whereby the external power source supplies power to power circuitry 787. As a further example, power source 786 may comprise a source of power in the form of a battery or battery pack which is connected to, or integrated in, power circuitry 787. The battery may provide backup power should the external power source fail. Other types of power sources, such as photovoltaic devices, may also be used.

Alternative embodiments of network node 760 may include additional components beyond those shown in FIG. 7 that may be responsible for providing certain aspects of the network node's functionality, including any of the functionality described herein and/or any functionality necessary to support the subject matter described herein. For example, network node 760 may include user interface equipment to allow input of information into network node 760 and to allow output of information from network node 760. This may allow a user to perform diagnostic, maintenance, repair, and other administrative functions for network node 760. As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 710 includes antenna 711, interface 714, processing circuitry 720, device readable medium 730, user interface equipment 732, auxiliary equipment 734, power source 736 and power circuitry 737. WD 710 may include multiple sets of one or more of the illustrated components for different wireless technologies supported by WD 710, such as, for example, GSM, WCDMA, LTE, NR, WiFi, WiMAX, or Bluetooth wireless technologies, just to mention a few. These wireless technologies may be integrated into the same or different chips or set of chips as other components within WD 710.

Antenna 711 may include one or more antennas or antenna arrays, configured to send and/or receive wireless signals, and is connected to interface 714. In certain alternative embodiments, antenna 711 may be separate from WD 710 and be connectable to WD 710 through an interface or port. Antenna 711, interface 714, and/or processing circuitry 720 may be configured to perform any receiving or transmitting operations described herein as being performed by a WD. Any information, data and/or signals may be received from a network node and/or another WD. In some embodiments, radio front end circuitry and/or antenna 711 may be considered an interface.

As illustrated, interface 714 comprises radio front end circuitry 712 and antenna 711. Radio front end circuitry 712 comprise one or more filters 718 and amplifiers 716. Radio front end circuitry 714 is connected to antenna 711 and processing circuitry 720, and is configured to condition signals communicated between antenna 711 and processing circuitry 720. Radio front end circuitry 712 may be coupled to or a part of antenna 711. In some embodiments, WD 710 may not include separate radio front end circuitry 712; rather, processing circuitry 720 may comprise radio front end circuitry and may be connected to antenna 711. Similarly, in some embodiments, some or all of RF transceiver circuitry 722 may be considered a part of interface 714. Radio front end circuitry 712 may receive digital data that is to be sent out to other network nodes or WDs via a wireless connection. Radio front end circuitry 712 may convert the digital data into a radio signal having the appropriate channel and bandwidth parameters using a combination of filters 718 and/or amplifiers 716. The radio signal may then be transmitted via antenna 711. Similarly, when receiving data, antenna 711 may collect radio signals which are then converted into digital data by radio front end circuitry 712. The digital data may be passed to processing circuitry 720. In other embodiments, the interface may comprise different components and/or different combinations of components.

Processing circuitry 720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 710 components, such as device readable medium 730, WD 710 functionality. Such functionality may include providing any of the various wireless features or benefits discussed herein. For example, processing circuitry 720 may execute instructions stored in device readable medium 730 or in memory within processing circuitry 720 to provide the functionality disclosed herein.

As illustrated, processing circuitry 720 includes one or more of RF transceiver circuitry 722, baseband processing circuitry 724, and application processing circuitry 726. In other embodiments, the processing circuitry may comprise different components and/or different combinations of components. In certain embodiments processing circuitry 720 of WD 710 may comprise a SOC. In some embodiments, RF transceiver circuitry 722, baseband processing circuitry 724, and application processing circuitry 726 may be on separate chips or sets of chips. In alternative embodiments, part or all of baseband processing circuitry 724 and application processing circuitry 726 may be combined into one chip or set of chips, and RF transceiver circuitry 722 may be on a separate chip or set of chips. In still alternative embodiments, part or all of RF transceiver circuitry 722 and baseband processing circuitry 724 may be on the same chip or set of chips, and application processing circuitry 726 may be on a separate chip or set of chips. In yet other alternative embodiments, part or all of RF transceiver circuitry 722, baseband processing circuitry 724, and application processing circuitry 726 may be combined in the same chip or set of chips. In some embodiments, RF transceiver circuitry 722 may be a part of interface 714. RF transceiver circuitry 722 may condition RF signals for processing circuitry 720.

In certain embodiments, some or all of the functionality described herein as being performed by a WD may be provided by processing circuitry 720 executing instructions stored on device readable medium 730, which in certain embodiments may be a computer-readable storage medium. In alternative embodiments, some or all of the functionality may be provided by processing circuitry 720 without executing instructions stored on a separate or discrete device readable storage medium, such as in a hard-wired manner. In any of those particular embodiments, whether executing instructions stored on a device readable storage medium or not, processing circuitry 720 can be configured to perform the described functionality. The benefits provided by such functionality are not limited to processing circuitry 720 alone or to other components of WD 710, but are enjoyed by WD 710 as a whole, and/or by end users and the wireless network generally.

Processing circuitry 720 may be configured to perform any determining, calculating, or similar operations (e.g., certain obtaining operations) described herein as being performed by a WD. These operations, as performed by processing circuitry 720, may include processing information obtained by processing circuitry 720 by, for example, converting the obtained information into other information, comparing the obtained information or converted information to information stored by WD 710, and/or performing one or more operations based on the obtained information or converted information, and as a result of said processing making a determination.

Device readable medium 730 may be operable to store a computer program, software, an application including one or more of logic, rules, code, tables, etc. and/or other instructions capable of being executed by processing circuitry 720. Device readable medium 730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 720. In some embodiments, processing circuitry 720 and device readable medium 730 may be considered to be integrated.

User interface equipment 732 may provide components that allow for a human user to interact with WD 710. Such interaction may be of many forms, such as visual, audial, tactile, etc. User interface equipment 732 may be operable to produce output to the user and to allow the user to provide input to WD 710. The type of interaction may vary depending on the type of user interface equipment 732 installed in WD 710. For example, if WD 710 is a smart phone, the interaction may be via a touch screen; if WD 710 is a smart meter, the interaction may be through a screen that provides usage (e.g., the number of gallons used) or a speaker that provides an audible alert (e.g., if smoke is detected). User interface equipment 732 may include input interfaces, devices and circuits, and output interfaces, devices and circuits. User interface equipment 732 is configured to allow input of information into WD 710, and is connected to processing circuitry 720 to allow processing circuitry 720 to process the input information. User interface equipment 732 may include, for example, a microphone, a proximity or other sensor, keys/buttons, a touch display, one or more cameras, a USB port, or other input circuitry. User interface equipment 732 is also configured to allow output of information from WD 710, and to allow processing circuitry 720 to output information from WD 710. User interface equipment 732 may include, for example, a speaker, a display, vibrating circuitry, a USB port, a headphone interface, or other output circuitry. Using one or more input and output interfaces, devices, and circuits, of user interface equipment 732, WD 710 may communicate with end users and/or the wireless network, and allow them to benefit from the functionality described herein.

Auxiliary equipment 734 is operable to provide more specific functionality which may not be generally performed by WDs. This may comprise specialized sensors for doing measurements for various purposes, interfaces for additional types of communication such as wired communications etc. The inclusion and type of components of auxiliary equipment 734 may vary depending on the embodiment and/or scenario.

Power source 736 may, in some embodiments, be in the form of a battery or battery pack. Other types of power sources, such as an external power source (e.g., an electricity outlet), photovoltaic devices or power cells, may also be used. WD 710 may further comprise power circuitry 737 for delivering power from power source 736 to the various parts of WD 710 which need power from power source 736 to carry out any functionality described or indicated herein. Power circuitry 737 may in certain embodiments comprise power management circuitry. Power circuitry 737 may additionally or alternatively be operable to receive power from an external power source; in which case WD 710 may be connectable to the external power source (such as an electricity outlet) via input circuitry or an interface such as an electrical power cable. Power circuitry 737 may also in certain embodiments be operable to deliver power from an external power source to power source 736. This may be, for example, for the charging of power source 736. Power circuitry 737 may perform any formatting, converting, or other modification to the power from power source 736 to make the power suitable for the respective components of WD 710 to which power is supplied.

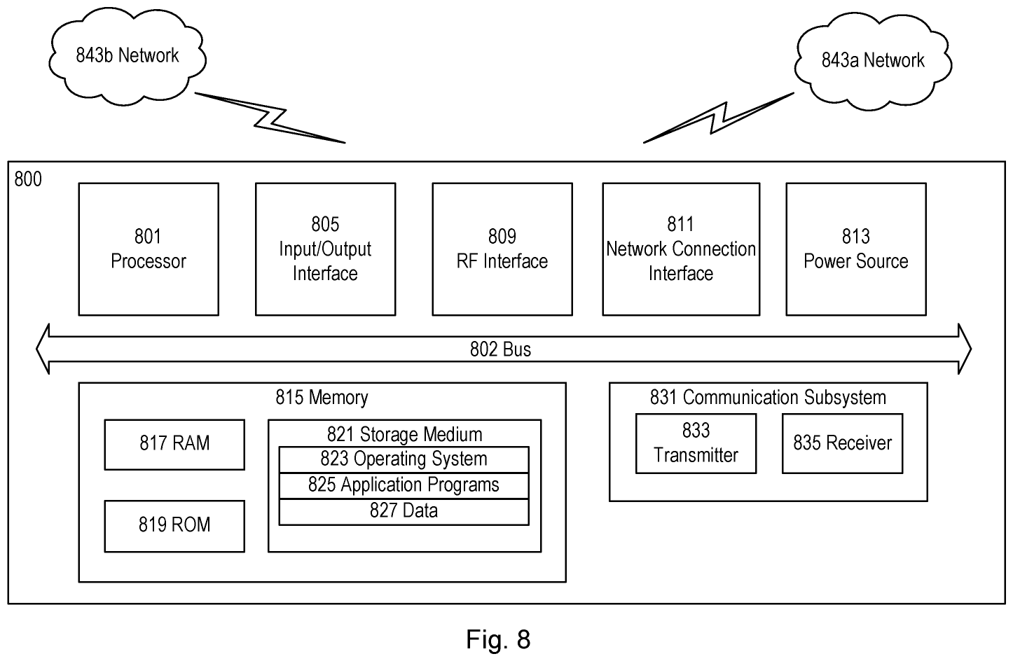

FIG. 8 shows a User Equipment in accordance with some embodiments.

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 800 may be any UE identified by the 3^{rd} Generation Partnership Project (3GPP), including a NB-IoT UE, a machine type communication (MTC) UE, and/or an enhanced MTC (eMTC) UE. UE 800, as illustrated in FIG. 8, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 8 is a UE, the components discussed herein are equally applicable to a WD, and vice-versa.

In FIG. 8, UE 800 includes processing circuitry 801 that is operatively coupled to input/output interface 805, radio frequency (RF) interface 809, network connection interface 811, memory 815 including random access memory (RAM) 817, read-only memory (ROM) 819, and storage medium 821 or the like, communication subsystem 831, power source 833, and/or any other component, or any combination thereof. Storage medium 821 includes operating system 823, application program 825, and data 827. In other embodiments, storage medium 821 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 801 may be configured to process computer instructions and data. Processing circuitry 801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 801 may include two central processing units (CPUs). Data may be information in a form suitable for use by a computer.

In the depicted embodiment, input/output interface 805 may be configured to provide a communication interface to an input device, output device, or input and output device. UE 800 may be configured to use an output device via input/output interface 805. An output device may use the same type of interface port as an input device. For example, a USB port may be used to provide input to and output from UE 800. The output device may be a speaker, a sound card, a video card, a display, a monitor, a printer, an actuator, an emitter, a smartcard, another output device, or any combination thereof. UE 800 may be configured to use an input device via input/output interface 805 to allow a user to capture information into UE 800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 809 may be configured to provide a communication interface to RF components such as a transmitter, a receiver, and an antenna. Network connection interface 811 may be configured to provide a communication interface to network 843a. Network 843a may encompass wired and/or wireless networks such as a local-area network (LAN), a wide-area network (WAN), a computer network, a wireless network, a telecommunications network, another like network or any combination thereof. For example, network 843a may comprise a Wi-Fi network. Network connection interface 811 may be configured to include a receiver and a transmitter interface used to communicate with one or more other devices over a communication network according to one or more communication protocols, such as Ethernet, TCP/IP, SONET, ATM, or the like. Network connection interface 811 may implement receiver and transmitter functionality appropriate to the communication network links (e.g., optical, electrical, and the like). The transmitter and receiver functions may share circuit components, software or firmware, or alternatively may be implemented separately.

RAM 817 may be configured to interface via bus 802 to processing circuitry 801 to provide storage or caching of data or computer instructions during the execution of software programs such as the operating system, application programs, and device drivers. ROM 819 may be configured to provide computer instructions or data to processing circuitry 801. For example, ROM 819 may be configured to store invariant low-level system code or data for basic system functions such as basic input and output (I/O), startup, or reception of keystrokes from a keyboard that are stored in a non-volatile memory. Storage medium 821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 821 may be configured to include operating system 823, application program 825 such as a web browser application, a widget or gadget engine or another application, and data file 827. Storage medium 821 may store, for use by UE 800, any of a variety of various operating systems or combinations of operating systems.

Storage medium 821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 821 may allow UE 800 to access computer-executable instructions, application programs or the like, stored on transitory or non-transitory memory media, to off-load data, or to upload data. An article of manufacture, such as one utilizing a communication system may be tangibly embodied in storage medium 821, which may comprise a device readable medium.

In FIG. 8, processing circuitry 801 may be configured to communicate with network 843b using communication subsystem 831. Network 843a and network 843b may be the same network or networks or different network or networks. Communication subsystem 831 may be configured to include one or more transceivers used to communicate with network 843b. For example, communication subsystem 831 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 833 and/or receiver 835 to implement transmitter or receiver functionality, respectively, appropriate to the RAN links (e.g., frequency allocations and the like). Further, transmitter 833 and receiver 835 of each transceiver may share circuit components, software or firmware, or alternatively may be implemented separately.

In the illustrated embodiment, the communication functions of communication subsystem 831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 831 may include cellular communication, Wi-Fi communication, Bluetooth communication, and GPS communication. Network 843b may encompass wired and/or wireless networks such as a local-area network (LAN), a wide-area network (WAN), a computer network, a wireless network, a telecommunications network, another like network or any combination thereof. For example, network 843b may be a cellular network, a Wi-Fi network, and/or a near-field network. Power source 813 may be configured to provide alternating current (AC) or direct current (DC) power to components of UE 800.

The features, benefits and/or functions described herein may be implemented in one of the components of UE 800 or partitioned across multiple components of UE 800. Further, the features, benefits, and/or functions described herein may be implemented in any combination of hardware, software or firmware. In one example, communication subsystem 831 may be configured to include any of the components described herein. Further, processing circuitry 801 may be configured to communicate with any of such components over bus 802. In another example, any of such components may be represented by program instructions stored in memory that when executed by processing circuitry 801 perform the corresponding functions described herein. In another example, the functionality of any of such components may be partitioned between processing circuitry 801 and communication subsystem 831. In another example, the non-computationally intensive functions of any of such components may be implemented in software or firmware and the computationally intensive functions may be implemented in hardware.

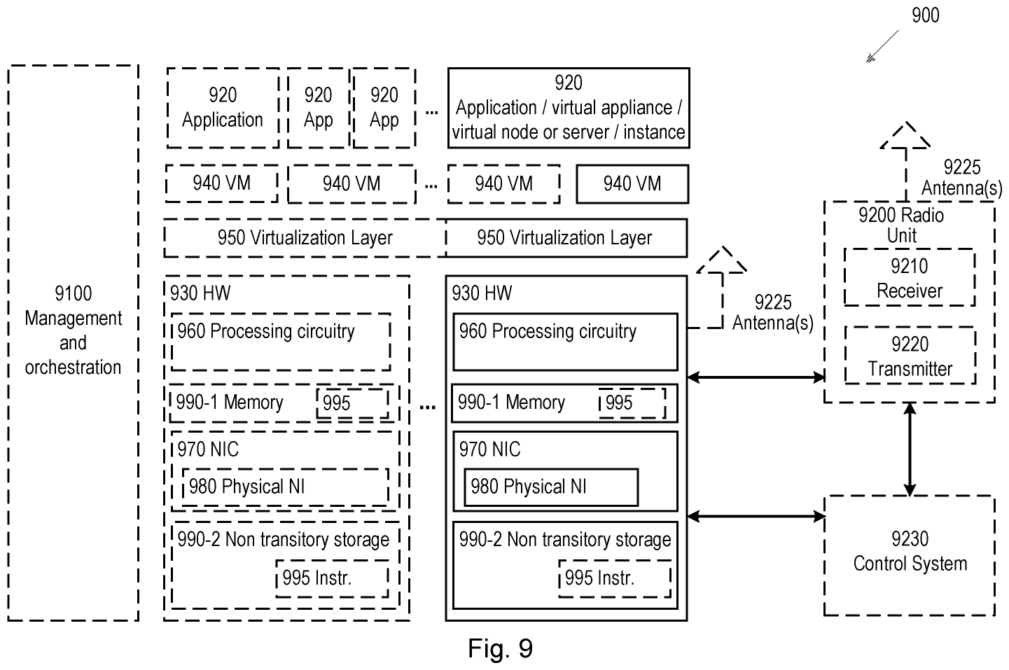

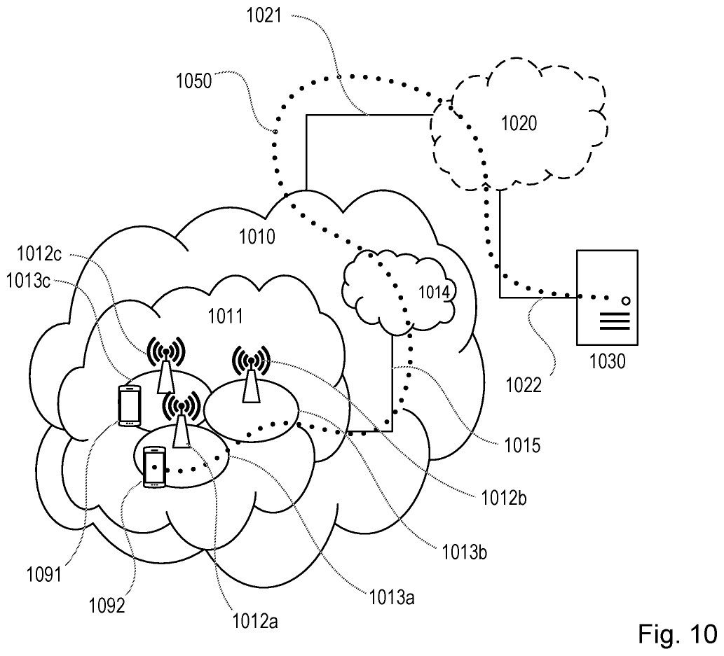

FIG. 9 shows a Virtualization environment in accordance with some embodiments.

FIG. 9 is a schematic block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 900 hosted by one or more of hardware nodes 930. Further, in embodiments in which the virtual node is not a radio access node or does not require radio connectivity (e.g., a core network node), then the network node may be entirely virtualized.

The functions may be implemented by one or more applications 920 (which may alternatively be called software instances, virtual appliances, network functions, virtual nodes, virtual network functions, etc.) operative to implement some of the features, functions, and/or benefits of some of the embodiments disclosed herein. Applications 920 are run in virtualization environment 900 which provides hardware 930 comprising processing circuitry 960 and memory 990. Memory 990 contains instructions 995 executable by processing circuitry 960 whereby application 920 is operative to provide one or more of the features, benefits, and/or functions disclosed herein.

Virtualization environment 900, comprises general-purpose or special-purpose network hardware devices 930 comprising a set of one or more processors or processing circuitry 960, which may be commercial off-the-shelf (COTS) processors, dedicated Application Specific Integrated Circuits (ASICs), or any other type of processing circuitry including digital or analog hardware components or special purpose processors. Each hardware device may comprise memory 990-1 which may be non-persistent memory for temporarily storing instructions 995 or software executed by processing circuitry 960. Each hardware device may comprise one or more network interface controllers (NICs) 970, also known as network interface cards, which include physical network interface 980. Each hardware device may also include non-transitory, persistent, machine-readable storage media 990-2 having stored therein software 995 and/or instructions executable by processing circuitry 960. Software 995 may include any type of software including software for instantiating one or more virtualization layers 950 (also referred to as hypervisors), software to execute virtual machines 940 as well as software allowing it to execute functions, features and/or benefits described in relation with some embodiments described herein.

Virtual machines 940, comprise virtual processing, virtual memory, virtual networking or interface and virtual storage, and may be run by a corresponding virtualization layer 950 or hypervisor. Different embodiments of the instance of virtual appliance 920 may be implemented on one or more of virtual machines 940, and the implementations may be made in different ways.

During operation, processing circuitry 960 executes software 995 to instantiate the hypervisor or virtualization layer 950, which may sometimes be referred to as a virtual machine monitor (VMM). Virtualization layer 950 may present a virtual operating platform that appears like networking hardware to virtual machine 940.

As shown in FIG. 9, hardware 930 may be a standalone network node with generic or specific components. Hardware 930 may comprise antenna 9225 and may implement some functions via virtualization. Alternatively, hardware 930 may be part of a larger cluster of hardware (e.g. such as in a data center or customer premise equipment (CPE)) where many hardware nodes work together and are managed via management and orchestration (MANO) 9100, which, among others, oversees lifecycle management of applications 920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 940 may be a software implementation of a physical machine that runs programs as if they were executing on a physical, non-virtualized machine. Each of virtual machines 940, and that part of hardware 930 that executes that virtual machine, be it hardware dedicated to that virtual machine and/or hardware shared by that virtual machine with others of the virtual machines 940, forms a separate virtual network elements (VNE).

Still in the context of NFV, Virtual Network Function (VNF) is responsible for handling specific network functions that run in one or more virtual machines 940 on top of hardware networking infrastructure 930 and corresponds to application 920 in FIG. 9.

In some embodiments, one or more radio units 9200 that each include one or more transmitters 9220 and one or more receivers 9210 may be coupled to one or more antennas 9225. Radio units 9200 may communicate directly with hardware nodes 930 via one or more appropriate network interfaces and may be used in combination with the virtual components to provide a virtual node with radio capabilities, such as a radio access node or a base station.

In some embodiments, some signalling can be effected with the use of control system 9230 which may alternatively be used for communication between the hardware nodes 930 and radio units 9200.

FIG. 10 shows a Telecommunication network connected via an intermediate network to a host computer in accordance with some embodiments

With reference to FIG. 10, in accordance with an embodiment, a communication system includes telecommunication network 1010, such as a 3GPP-type cellular network, which comprises access network 1011, such as a radio access network, and core network 1014. Access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to core network 1014 over a wired or wireless connection 1015. A first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Telecommunication network 1010 is itself connected to host computer 1030, which may be embodied in the hardware and/or software of a standalone server, a cloud-implemented server, a distributed server or as processing resources in a server farm. Host computer 1030 may be under the ownership or control of a service provider, or may be operated by the service provider or on behalf of the service provider. Connections 1021 and 1022 between telecommunication network 1010 and host computer 1030 may extend directly from core network 1014 to host computer 1030 or may go via an optional intermediate network 1020. Intermediate network 1020 may be one of, or a combination of more than one of, a public, private or hosted network; intermediate network 1020, if any, may be a backbone network or the Internet; in particular, intermediate network 1020 may comprise two or more sub-networks (not shown).

The communication system of FIG. 10 as a whole enables connectivity between the connected UEs 1091, 1092 and host computer 1030. The connectivity may be described as an over-the-top (OTT) connection 1050. Host computer 1030 and the connected UEs 1091, 1092 are configured to communicate data and/or signaling via OTT connection 1050, using access network 1011, core network 1014, any intermediate network 1020 and possible further infrastructure (not shown) as intermediaries. OTT connection 1050 may be transparent in the sense that the participating communication devices through which OTT connection 1050 passes are unaware of routing of uplink and downlink communications. For example, base station 1012 may not or need not be informed about the past routing of an incoming downlink communication with data originating from host computer 1030 to be forwarded (e.g., handed over) to a connected UE 1091. Similarly, base station 1012 need not be aware of the future routing of an outgoing uplink communication originating from the UE 1091 towards the host computer 1030.

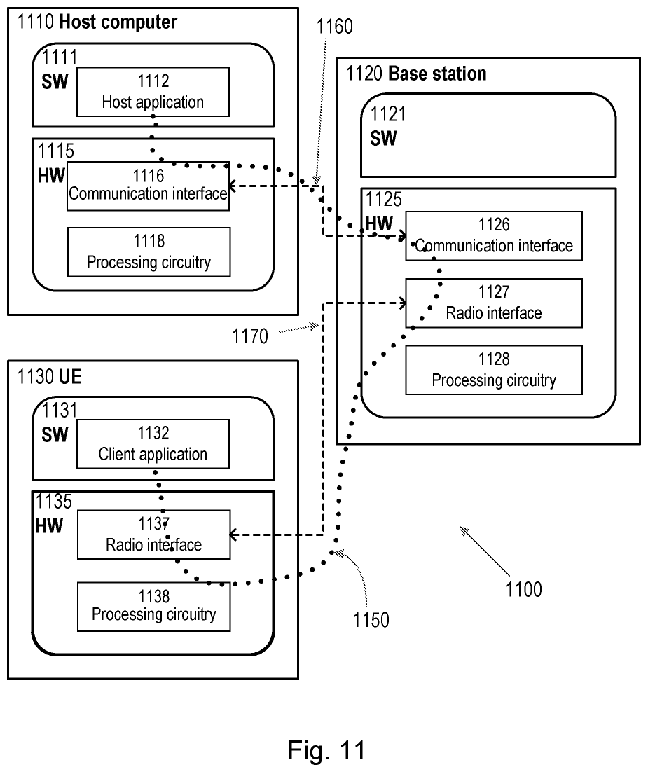

FIG. 11 shows a Host computer communicating via a base station with a user equipment over a partially wireless connection in accordance with some embodiments

Example implementations, in accordance with an embodiment, of the UE, base station and host computer discussed in the preceding paragraphs will now be described with reference to FIG. 11. In communication system 1100, host computer 1110 comprises hardware 1115 including communication interface 1116 configured to set up and maintain a wired or wireless connection with an interface of a different communication device of communication system 1100. Host computer 1110 further comprises processing circuitry 1118, which may have storage and/or processing capabilities. In particular, processing circuitry 1118 may comprise one or more programmable processors, application-specific integrated circuits, field programmable gate arrays or combinations of these (not shown) adapted to execute instructions. Host computer 1110 further comprises software 1111, which is stored in or accessible by host computer 1110 and executable by processing circuitry 1118. Software 1111 includes host application 1112. Host application 1112 may be operable to provide a service to a remote user, such as UE 1130 connecting via OTT connection 1150 terminating at UE 1130 and host computer 1110. In providing the service to the remote user, host application 1112 may provide user data which is transmitted using OTT connection 1150.

Communication system 1100 further includes base station 1120 provided in a telecommunication system and comprising hardware 1125 enabling it to communicate with host computer 1110 and with UE 1130. Hardware 1125 may include communication interface 1126 for setting up and maintaining a wired or wireless connection with an interface of a different communication device of communication system 1100, as well as radio interface 1127 for setting up and maintaining at least wireless connection 1170 with UE 1130 located in a coverage area (not shown in FIG. 11) served by base station 1120. Communication interface 1126 may be configured to facilitate connection 1160 to host computer 1110. Connection 1160 may be direct or it may pass through a core network (not shown in FIG. 11) of the telecommunication system and/or through one or more intermediate networks outside the telecommunication system. In the embodiment shown, hardware 1125 of base station 1120 further includes processing circuitry 1128, which may comprise one or more programmable processors, application-specific integrated circuits, field programmable gate arrays or combinations of these (not shown) adapted to execute instructions. Base station 1120 further has software 1121 stored internally or accessible via an external connection.

Communication system 1100 further includes UE 1130 already referred to. Its hardware 1135 may include radio interface 1137 configured to set up and maintain wireless connection 1170 with a base station serving a coverage area in which UE 1130 is currently located. Hardware 1135 of UE 1130 further includes processing circuitry 1138, which may comprise one or more programmable processors, application-specific integrated circuits, field programmable gate arrays or combinations of these (not shown) adapted to execute instructions. UE 1130 further comprises software 1131, which is stored in or accessible by UE 1130 and executable by processing circuitry 1138. Software 1131 includes client application 1132. Client application 1132 may be operable to provide a service to a human or non-human user via UE 1130, with the support of host computer 1110. In host computer 1110, an executing host application 1112 may communicate with the executing client application 1132 via OTT connection 1150 terminating at UE 1130 and host computer 1110. In providing the service to the user, client application 1132 may receive request data from host application 1112 and provide user data in response to the request data. OTT connection 1150 may transfer both the request data and the user data. Client application 1132 may interact with the user to generate the user data that it provides.

It is noted that host computer 1110, base station 1120 and UE 1130 illustrated in FIG. 11 may be similar or identical to host computer 1030, one of base stations 1012a, 1012b, 1012c and one of UEs 1091, 1092 of FIG. 10, respectively. This is to say, the inner workings of these entities may be as shown in FIG. 11 and independently, the surrounding network topology may be that of FIG. 10.

In FIG. 11, OTT connection 1150 has been drawn abstractly to illustrate the communication between host computer 1110 and UE 1130 via base station 1120, without explicit reference to any intermediary devices and the precise routing of messages via these devices. Network infrastructure may determine the routing, which it may be configured to hide from UE 1130 or from the service provider operating host computer 1110, or both. While OTT connection 1150 is active, the network infrastructure may further take decisions by which it dynamically changes the routing (e.g., on the basis of load balancing consideration or reconfiguration of the network).

Wireless connection 1170 between UE 1130 and base station 1120 is in accordance with the teachings of the embodiments described throughout this disclosure. One or more of the various embodiments improve the performance of OTT services provided to UE 1130 using OTT connection 1150, in which wireless connection 1170 forms the last segment. More precisely, the teachings of these embodiments may improve the QOE metrics taken for a particular application and thereby provide benefits such as improved quality of experience.

A measurement procedure may be provided for the purpose of monitoring data rate, latency and other factors on which the one or more embodiments improve. There may further be an optional network functionality for reconfiguring OTT connection 1150 between host computer 1110 and UE 1130, in response to variations in the measurement results. The measurement procedure and/or the network functionality for reconfiguring OTT connection 1150 may be implemented in software 1111 and hardware 1115 of host computer 1110 or in software 1131 and hardware 1135 of UE 1130, or both. In embodiments, sensors (not shown) may be deployed in or in association with communication devices through which OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of OTT connection 1150 may include message format, retransmission settings, preferred routing etc.; the reconfiguring need not affect base station 1120, and it may be unknown or imperceptible to base station 1120. Such procedures and functionalities may be known and practiced in the art. In certain embodiments, measurements may involve proprietary UE signaling facilitating host computer 1110's measurements of throughput, propagation times, latency and the like. The measurements may be implemented in that software 1111 and 1131 causes messages to be transmitted, in particular empty or ‘dummy’ messages, using OTT connection 1150 while it monitors propagation times, errors etc.

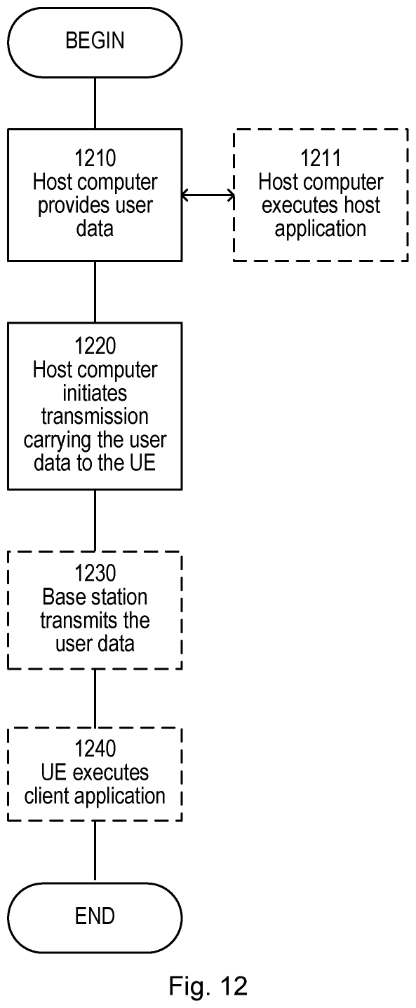

FIG. 12 illustrates methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 1210, the host computer provides user data. In substep 1211 (which may be optional) of step 1210, the host computer provides the user data by executing a host application. In step 1220, the host computer initiates a transmission carrying the user data to the UE. In step 1230 (which may be optional), the base station transmits to the UE the user data which was carried in the transmission that the host computer initiated, in accordance with the teachings of the embodiments described throughout this disclosure. In step 1240 (which may also be optional), the UE executes a client application associated with the host application executed by the host computer.

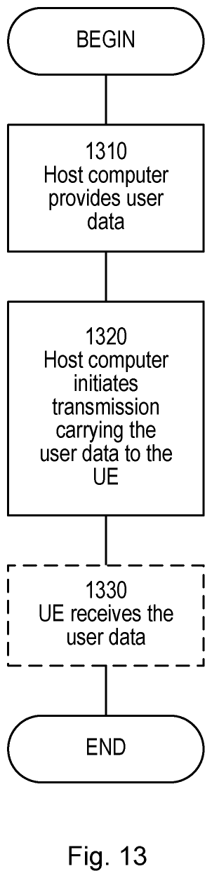

FIG. 13 illustrates methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 1310 of the method, the host computer provides user data. In an optional substep (not shown) the host computer provides the user data by executing a host application. In step 1320, the host computer initiates a transmission carrying the user data to the UE. The transmission may pass via the base station, in accordance with the teachings of the embodiments described throughout this disclosure. In step 1330 (which may be optional), the UE receives the user data carried in the transmission.

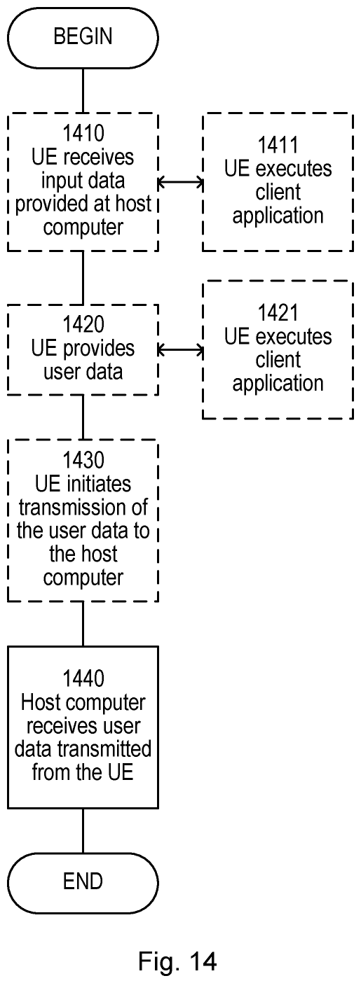

FIG. 14 illustrates methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1410 (which may be optional), the UE receives input data provided by the host computer. Additionally or alternatively, in step 1420, the UE provides user data. In substep 1421 (which may be optional) of step 1420, the UE provides the user data by executing a client application. In substep 1411 (which may be optional) of step 1410, the UE executes a client application which provides the user data in reaction to the received input data provided by the host computer. In providing the user data, the executed client application may further consider user input received from the user. Regardless of the specific manner in which the user data was provided, the UE initiates, in substep 1430 (which may be optional), transmission of the user data to the host computer. In step 1440 of the method, the host computer receives the user data transmitted from the UE, in accordance with the teachings of the embodiments described throughout this disclosure.

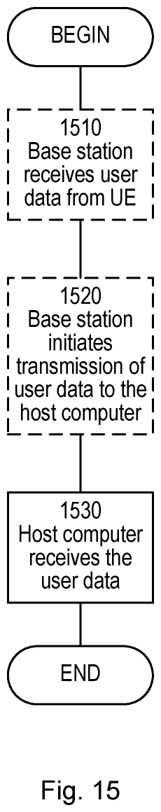

FIG. 15 illustrates methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1510 (which may be optional), in accordance with the teachings of the embodiments described throughout this disclosure, the base station receives user data from the UE. In step 1520 (which may be optional), the base station initiates transmission of the received user data to the host computer. In step 1530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

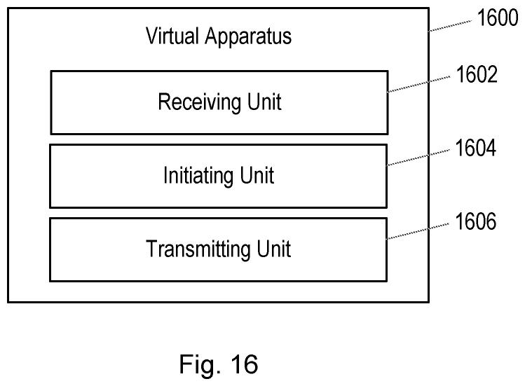

FIG. 16 illustrates a virtualization apparatus in accordance with some embodiments.

FIG. 16 illustrates a schematic block diagram of an apparatus 1600 in a wireless network (for example, the wireless network shown in FIG. 7). The apparatus may be implemented in a wireless device (e.g., wireless device 710 shown in FIG. 7). Apparatus 1600 is operable to carry out the example method described with reference to FIG. 4 and possibly other processes or methods disclosed herein. It is also to be understood that the method of FIG. 4 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1602, initiating unit 1604, and transmitting unit 1606, and any other suitable units of apparatus 1600 to perform corresponding functions according one or more embodiments of the present disclosure.

As illustrated in FIG. 16, apparatus 1600 includes receiving unit 1602, initiating unit 1604, and transmitting unit 1606. Receiving unit 1602 is configured to receive, from a base station, a first request to perform one or more measurements according to a QoE measurement configuration, wherein the request comprises an indication of the Quality of Experience measurement configuration, wherein the QoE measurement configuration is associated with a service type of a first application and at least one service subtype of the first application. Initiating unit 1604 is configured to initiate one or more QoE measurements according to the QoE measurement configuration. Transmitting unit 1606 is configured to transmit a QoE measurement report comprising results of the one or more QoE measurements to the base station.

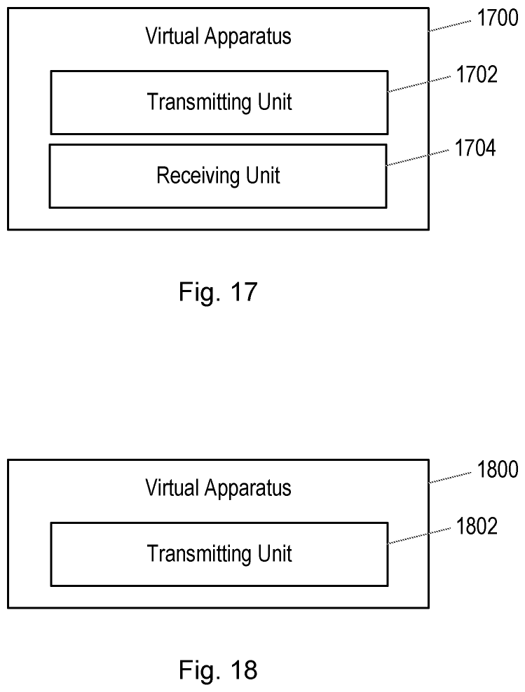

FIG. 17 illustrates a virtualization apparatus in accordance with some embodiments.

FIG. 17 illustrates a schematic block diagram of an apparatus 1700 in a wireless network (for example, the wireless network shown in FIG. 7). The apparatus may be implemented in a network node (e.g. network node QQ1760 shown in FIG. 7). Apparatus 1700 is operable to carry out the example method described with reference to FIG. 5 and possibly other processes or methods disclosed herein. It is also to be understood that the method of FIG. 5 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1702 and receiving unit 1704, and any other suitable units of apparatus 1700 to perform corresponding functions according one or more embodiments of the present disclosure.

As illustrated in FIG. 17, apparatus 1700 includes transmitting unit 1702 and receiving unit 1704. Transmitting unit 1702 is configured to transmit, to a wireless device, a first request to perform one or more measurements according to a Quality of Experience measurement configuration, wherein the request comprises an indication of the Quality of Experience measurement configuration, and wherein the QoE measurement configuration is associated with a service type of a first application and at least one service subtype of the first application. Receiving unit 1704 is configured to receive a QoE measurement report associated with the QoE measurement configuration.

FIG. 18 illustrates a virtualization apparatus in accordance with some embodiments.

FIG. 18 illustrates a schematic block diagram of an apparatus 1800 in a wireless network (for example, the wireless network shown in FIG. 7). The apparatus may be implemented in a network node (e.g., network node 760 shown in FIG. 7). Apparatus 1800 is operable to carry out the example method described with reference to FIG. 6 and possibly other processes or methods disclosed herein. It is also to be understood that the method of FIG. 6 is not necessarily carried out solely by apparatus 1800. At least some operations of the method can be performed by one or more other entities.

Virtual Apparatus 1800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1802, and any other suitable units of apparatus 1800 to perform corresponding functions according one or more embodiments of the present disclosure.

As illustrated in FIG. 18, apparatus 1800 includes transmitting unit 1802. Transmitting unit 1802 is configured to transmit to a base station, a set of QoE measurement configurations comprising a QoE measurement configuration, wherein the QoE measurement configuration is associated with a service type of the first application and at least one service subtype of the first application.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Embodiments of the techniques, apparatuses, and systems described herein include the following enumerated examples:

### Group A Embodiments

1. A method performed by a wireless device for initiating performance of Quality of Experience, QoE, measurements for a first application, the method comprising:
receiving, from a base station, a first request to perform one or more measurements according to a QoE measurement configuration, wherein the request comprises an indication of the QoE measurement configuration, wherein the QoE measurement configuration is associated with a service type of a first application and at least one service subtype of the first application;
initiating one or more QoE measurements according to the QoE measurement configuration; and
transmitting a QoE measurement report comprising results of the one or more QoE measurements to the base station.

2. The method of embodiment 1 wherein the first request comprises an indication of a plurality of QoE measurement configurations, wherein each of the plurality of QoE measurement configurations is respectively associated with a service type of a second application and at least one service subtype of the second application.

3. The method of embodiment 1 or 2 wherein the indication of the QoE measurement configuration comprises a unique QoE reference identifier.

4. The method of any previous embodiment further comprising:
receiving, from the base station, a second request to pause or release the QoE measurement configuration, wherein the second request comprises the indication of the QoE measurement configuration; and
initiating pausing or releasing of the QoE measurement configuration.

5. The method of any previous embodiment wherein the step of initiating the one or more measurements comprises transmitting the QoE measurement configuration to an application layer or an Application Programming Interface, API.

6. The method of embodiment 5 further comprising receiving the QoE measurement report from the application layer or API.

7. The method of any previous embodiment wherein the service type of the first application and the at least one service subtype of the first application are indicated in separate information elements.

8. The method of any one of embodiments 1 to 6 wherein the service type of the first application and the at least one service subtype of the first application are indicated in a single information element.

9. The method of any previous embodiment wherein the QoE measurement configuration is associated with a plurality of service types.

10. The method of any previous embodiment wherein the service type of the first application is associated with a first set of QoE metrics, and the at least one service subtype is associated with a second set of QoE metrics, wherein the QoE measurement configuration comprises both the first set of QoE metrics and the second set of QoE metrics.

11. The method of embodiment 10 wherein the first set of QoE metrics is associated with a first set of QoE measurements and/or a first set of QoE reporting schemes; and the second set of QoE metrics is associated with a second set of QoE measurements and/or a second set of QoE reporting schemes.

12. The method of any of the previous embodiments, further comprising:
providing user data; and
forwarding the user data to a host computer via the transmission to the base station.

### Group B Embodiments

13. A method performed by a base station for initiating performance of Quality of Experience, QoE, measurements for a first application, the method comprising:
transmitting, to a wireless device, a first request to perform one or more measurements according to a QoE measurement configuration, wherein the request comprises an indication of the QoE measurement configuration, and wherein the QoE measurement configuration is associated with a service type of a first application and at least one service subtype of the first application; and
receiving a QoE measurement report associated with the QoE measurement configuration.

14. The method of embodiment 13 wherein the first request comprises an indication of a plurality of QoE measurement configurations, wherein each of the plurality of QoE measurements configurations is respectively associated with a service type of a second application and at least one service subtype of the second application.

15. The method of embodiments 13 or 14 further comprising transmitting the first request to a plurality of wireless devices.

16. The method of embodiment 13 to 15 wherein the indication of the QoE measurement configuration comprises a unique QoE reference identifier.

17. The method of any one of embodiments 13 to 16 further comprising:
transmitting, to the wireless device, a second request to pause or release the QoE measurement configuration, wherein the second request comprises the indication of the QoE measurement configuration.

18. The method of any one of embodiments 13 to 17 further comprising:
receiving, from a network node, a set of QoE measurement configurations comprising the QoE measurement configuration.

19. The method of any one of embodiments 18 further comprising:
receiving, from the network node, an indication of an area scope in which the QoE measurement configuration is valid.

20. The method of any one of embodiments 18 to 19 further comprising:
receiving, from the network node, an indication of one or more Measurement Collection Entities, MCEs, associated with the first application to which the base station should send the QoE report.

21. The method of any one of embodiments 18 to 20 further comprising:
receiving, from the network node, information identifying the service type of the first application and information identifying the at least one service subtype of the first application.

22. The method of embodiment 21 wherein the information identifying the service type of the first application and information identifying the at least one service subtype of the first application form separate information elements.

23. The method of embodiment 21 wherein the information identifying the service type of the first application and information identifying the at least one service subtype of the first application are comprised in single information element.

24. The method of any one of embodiments 13 to 23 wherein the QoE measurement configuration is associated with a plurality of service types.

25. The method of any one of embodiments 13 to 24 wherein the service type of the first application is associated with a first set of QoE metrics, and the at least one service subtype is associated with a second set of QoE metrics, wherein the QoE measurement configuration comprises both the first set of QoE metrics and the second set of QoE metrics.

26. The method of embodiment 25 wherein the first set of QoE metrics is associated with a first set of QoE measurements and/or a first set of QoE reporting schemes; and the second set of QoE metrics is associated with a second set of QoE measurements and/or a second set of QoE reporting schemes.

27. The method of any of the previous embodiments, further comprising:
obtaining user data; and
forwarding the user data to a host computer or a wireless device.

### Group D Embodiments

28. A method performed by network node for initiating performance of Quality of Experience, QoE, measurements for a first application, the method comprising:
transmitting to a base station, a set of QoE measurement configurations comprising a QoE measurement configuration, wherein the QoE measurement configuration is associated with a service type of the first application and at least one service subtype of the first application.

29. method of any one of embodiments 28 further comprising:
transmitting, to the base station, an indication of an area scope in which the QoE measurement configuration is valid.

30. The method of any one of embodiments 28 to 29 further comprising:
transmitting, to the base station, an indication of one or more Measurement Collection Entities, MCEs, associated with the first application to which the base station should send a QoE report associated with the QoE measurement configuration.

31. The method of any one of embodiments 28 to 30 further comprising:
transmitting, to the base station, information identifying the service type of the first application and information identifying the at least one service subtype of the first application.

32. The method of any one of embodiments 28 to 31 wherein the information identifying the service type of the first application and information identifying the at least one service subtype of the first application form separate information elements.

33. The method of any one of embodiments 28 to 32 wherein the information identifying the service type of the first application and information identifying the at least one service subtype of the first application are comprised in single information element.

34. The method of any one of embodiments 28 to 33 wherein the QoE measurement configuration is associated with a plurality of service types.

35. The method of any one of embodiments 28 to 34 wherein the service type of the first application is associated with a first set of QoE metrics, and the at least one service subtype is associated with a second set of QoE metrics, wherein the QoE measurement configuration comprises both the first set of QoE metrics and the second set of QoE metrics.

36. The method of embodiment 35 wherein the first set of QoE metrics is associated with a first set of QoE measurements and/or a first set of QoE reporting schemes; and the second set of QoE metrics is associated with a second set of QoE measurements and/or a second set of QoE reporting schemes.

37. The method of embodiments 28 to 36 wherein the network node comprises an Operations, Administration and Maintenance (OAM) network node or a core network node.

### Group C Embodiments

38. A wireless device for initiating performance of Quality of Experience, QoE, measurements for a first application, the wireless device comprising:
processing circuitry configured to perform any of the steps of any of the Group A embodiments; and
power supply circuitry configured to supply power to the wireless device.

39. A base station for initiating performance of Quality of Experience, QoE, measurements for a first application, the base station comprising:
processing circuitry configured to perform any of the steps of any of the Group B embodiments;
power supply circuitry configured to supply power to the base station.

40. A user equipment (UE) for initiating performance of Quality of Experience, QoE, measurements for a first application, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

41. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

42. The communication system of the previous embodiment further including the base station.

43. The communication system of the previous 2 embodiments, further including the UE, wherein the UE is configured to communicate with the base station.

44. The communication system of the previous 3 embodiments, wherein:
the processing circuitry of the host computer is configured to execute a host application, thereby providing the user data; and
the UE comprises processing circuitry configured to execute a client application associated with the host application.

45. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

46. The method of the previous embodiment, further comprising, at the base station, transmitting the user data.

47. The method of the previous 2 embodiments, wherein the user data is provided at the host computer by executing a host application, the method further comprising, at the UE, executing a client application associated with the host application.

48. A user equipment (UE) configured to communicate with a base station, the UE comprising a radio interface and processing circuitry configured to performs the of the previous 3 embodiments.

49. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

50. The communication system of the previous embodiment, wherein the cellular network further includes a base station configured to communicate with the UE.

51. The communication system of the previous 2 embodiments, wherein:
the processing circuitry of the host computer is configured to execute a host application, thereby providing the user data; and
the UE's processing circuitry is configured to execute a client application associated with the host application.

52. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

53. The method of the previous embodiment, further comprising at the UE, receiving the user data from the base station.

54. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

55. The communication system of the previous embodiment, further including the UE.

56. The communication system of the previous 2 embodiments, further including the base station, wherein the base station comprises a radio interface configured to communicate with the UE and a communication interface configured to forward to the host computer the user data carried by a transmission from the UE to the base station.

57. The communication system of the previous 3 embodiments, wherein:
the processing circuitry of the host computer is configured to execute a host application; and
the UE's processing circuitry is configured to execute a client application associated with the host application, thereby providing the user data.

58. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

59. A method implemented in a communication system including a host computer, a base station and a user equipment (UE), the method comprising:
at the host computer, receiving user data transmitted to the base station from the UE, wherein the UE performs any of the steps of any of the Group A embodiments.

60. The method of the previous embodiment, further comprising, at the UE, providing the user data to the base station.

61. The method of the previous 2 embodiments, further comprising:
at the UE, executing a client application, thereby providing the user data to be transmitted; and
at the host computer, executing a host application associated with the client application.

62. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

63. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

64. The communication system of the previous embodiment further including the base station.

65. The communication system of the previous 2 embodiments, further including the UE, wherein the UE is configured to communicate with the base station.

66. The communication system of the previous 3 embodiments, wherein:
the processing circuitry of the host computer is configured to execute a host application;
the UE is configured to execute a client application associated with the host application, thereby providing the user data to be received by the host computer.

67. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

68. The method of the previous embodiment, further comprising at the base station, receiving the user data from the UE.

69. The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).

| Abbreviation | Explanation |
|---|---|
| 3GPP | 3rd Generation Partnership Project |
| 5GCN | 5G Core Network 5GS 5G System |
| AF | Application Function |
| AMF | Access and Mobility Management Function |
| AN | Access Network |
| API | Application Programming Interface |
| AGV | Automated Guided Vehicle |
| BAP | Backhaul Adaptation ProtocolCN Core Network |
| CNC | Central Network Controller |
| CP | Control Plane |
| CU | Central Unit |
| DC | Dual Connectivity |
| DU | Distributed Unit |
| DS-TT | Device-Side TSN translator |
| eNB | E-UTRAN NodeB |
| EN-DC | E-UTRA-NR Dual Connectivity |
| E-UTRA | Evolved UTRA |
| E-UTRAN | Evolved UTRAN |
| gNB | Radio base station in NR |
| IAB | Integrated Access and Backhaul |
| ID | Identifier/IdentityIE Information Element |
| LTE | Long Term Evolution |
| MCE | Measurement Collector Entity |
| MME | Mobility Management Entity |
| MN | Master Node |
| MR-DC | Multi-Radio Dual Connectivity |
| NE-DC | NR-E-UTRA Dual Connectivity |
| NEF | Network Exposure Function |
| NG | Next Generation |
| NGEN-DC | NG-RAN E-UTRA-NR Dual Connectivity |
| NG-RAN | NG Radio Access NetworkNR New Radio |
| NW-TT | Network-side TSN translator |
| OAM/O&M | Operation and Maintenance |
| PCF | Policy Control Function |
| QCI | QoS Class Identifier |
| QMC | QoE Measurement CollectionQoE Quality of Experience |
| QoS | Quality of Service |
| RAN | Radio Access Network |
| RAT | Radio Access Technology |
| RRC | Radio Resource Control |
| S1 | The interface between the RAN and the CN in LTE. |
| S1AP | S1 Application Protocol |
| SMF | Session Management Function |
| SMO | Service Management and Orchestration |
| SN | Secondary Node |
| TCE | Trace Collector Entity |
| TSC | Time Sensitive Communication |
| TSN | Time Sensitive Network |
| TSN-IA | Time Sensitive Network Industrial Automation |
| UDM | Unified Data Management |
| UE | User Equipment |
| UPF | User Plane Function |
| 1x RTT | CDMA2000 1x Radio Transmission Technology |
| 3GPP | 3rd Generation Partnership Project |
| 5G | 5th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH Ec/No | CPICH Received energy per chip divided by the power |
| | density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| E-SMLC | Evolved-Serving Mobile Location Centre |
| ECGI | Evolved CGI |
| eNB | E-UTRAN NodeB |
| ePDCCH | enhanced Physical Downlink Control Channel |
| E-SMLC | evolved Serving Mobile Location Center |
| E-UTRA | Evolved UTRA |
| E-UTRAN | Evolved UTRAN |
| FDD | Frequency Division Duplex |
| FFS | For Further Study |
| GERAN | GSM EDGE Radio Access Network |
| gNB | Base station in NR |
| GNSS | Global Navigation Satellite System |
| GSM | Global System for Mobile communication |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning ProtocolLTE Long-Term Evolution |
| MAC | Medium Access Control |
| MBMS | Multimedia Broadcast Multicast Services |
| MBSFN | Multimedia Broadcast multicast service Single |
| | Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of ArrivalO&M Operation |
| | and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR Reference |
| | Signal Received Power |
| RSRQ | Reference Signal Received Quality OR Reference |
| | Symbol Received Quality |
| RSSI | Received Signal Strength Indicator |
| RSTD | Reference Signal Time Difference |
| SCH | Synchronization Channel |
| SCell | Secondary Cell |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| UMTS | Universal Mobile Telecommunication System |
| USIM | Universal Subscriber Identity Module |
| UTDOA | Uplink Time Difference of Arrival |
| UTRA | Universal Terrestrial Radio Access |
| UTRAN | Universal Terrestrial Radio Access Network |
| WCDMA | Wide CDMA |
| WLAN | Wide Local Area Network |

1-30. (canceled)

31. A method performed by a wireless device for initiating performance of Quality of Experience (QoE) measurements for a first application, the method comprising:
receiving, from a base station, a first request to perform one or more measurements according to a QoE measurement configuration, wherein the request comprises an indication of the QoE measurement configuration, wherein the QoE measurement configuration is associated with a service type of a first application and at least one service subtype of the first application;
initiating one or more QoE measurements according to the QoE measurement configuration; and
transmitting a QoE measurement report comprising results of the one or more QoE measurements to the base station.

32. The method of claim 31, wherein the service type of the first application and the at least one service subtype of the first application are indicated in separate information elements.

33. The method of claim 31, wherein the service type of the first application is associated with a first set of QoE metrics, and the at least one service subtype is associated with a second set of QoE metrics, wherein the QoE measurement configuration comprises both the first set of QoE metrics and the second set of QoE metrics.

34. A method performed by a base station for initiating performance of Quality of Experience (QoE) measurements for a first application, the method comprising:
transmitting, to a wireless device, a first request to perform one or more measurements according to a QoE measurement configuration, wherein the request comprises an indication of the QoE measurement configuration, and wherein the QoE measurement configuration is associated with a service type of a first application and at least one service subtype of the first application; and
receiving a QoE measurement report associated with the QoE measurement configuration.

35. The method of claim 34, further comprising:
receiving, from a network node, a set of QoE measurement configurations comprising the QoE measurement configuration.

36. The method of claim 35, further comprising:
receiving, from the network node, information identifying the service type of the first application and information identifying the at least one service subtype of the first application.

37. The method of claim 36, wherein the information identifying the service type of the first application and information identifying the at least one service subtype of the first application form separate information elements.

38. The method of claim 34, wherein the service type of the first application is associated with a first set of QoE metrics, and the at least one service subtype is associated with a second set of QoE metrics, wherein the QoE measurement configuration comprises both the first set of QoE metrics and the second set of QoE metrics.

39. A wireless device for initiating performance of Quality of Experience (QoE) measurements for a first application, the wireless device comprising a processor and a memory, said memory containing instructions executable by said processor whereby said wireless device is operative to:
receive, from a base station, a first request to perform one or more measurements according to a QoE measurement configuration, wherein the request comprises an indication of the QoE measurement configuration, wherein the QoE measurement configuration is associated with a service type of a first application and at least one service subtype of the first application;
initiate one or more QoE measurements according to the QoE measurement configuration; and
transmit a QoE measurement report comprising results of the one or more QoE measurements to the base station.

40. The wireless device of claim 39, wherein the service type of the first application and the at least one service subtype of the first application are indicated in separate information elements.

41. The wireless device of claim 39, wherein the service type of the first application is associated with a first set of QoE metrics, and the at least one service subtype is associated with a second set of QoE metrics, wherein the QoE measurement configuration comprises both the first set of QoE metrics and the second set of QoE metrics.

42. A base station for initiating performance of Quality of Experience (QoE) measurements for a first application, the base station comprising a processor and a memory, said memory containing instructions executable by said processor whereby said base station is operative to:
transmit, to a wireless device, a first request to perform one or more measurements according to a QoE measurement configuration, wherein the request comprises an indication of the QoE measurement configuration, and wherein the QoE measurement configuration is associated with a service type of a first application and at least one service subtype of the first application; and
receive a QoE measurement report associated with the QoE measurement configuration.

43. The base station of claim 42, further comprising:
receiving, from a network node, a set of QoE measurement configurations comprising the QoE measurement configuration.

44. The base station of claim 43, wherein the base station is further operative to:
receive, from the network node, information identifying the service type of the first application and information identifying the at least one service subtype of the first application.

45. The base station of claim 44, wherein the information identifying the service type of the first application and information identifying the at least one service subtype of the first application form separate information elements.

46. The base station of claim 42, wherein the service type of the first application is associated with a first set of QoE metrics, and the at least one service subtype is associated with a second set of QoE metrics, wherein the QoE measurement configuration comprises both the first set of QoE metrics and the second set of QoE metrics.
